(19) United States
(12) Patent Application Publication
(10) Pub. No.: US 2024/0323043 A1
(43) Pub. Date: Sep. 26, 2024

(54) MANAGEMENT DEVICE, MANAGEMENT SYSTEM, MANAGEMENT METHOD, AND SETTING METHOD

(71) Applicant: Mitsubishi Electric Corporation, Tokyo (JP)

(72) Inventors: Reiko SAKATA, Tokyo (JP); Saki MATSUI, Tokyo (JP); Masami AIKAWA, Tokyo (JP); Eiji YUASA, Tokyo (JP)

(73) Assignee: Mitsubishi Electric Corporation, Tokyo (JP)

(21) Appl. No.: 18/672,283

(22) Filed: May 23, 2024

Related U.S. Application Data
(63) Continuation of application No. PCT/JP2022/035556, filed on Sep. 26, 2022.

(30) Foreign Application Priority Data
Dec. 23, 2021 (WO) PCT/JP2021/047791

(51) Int. Cl. H04L 12/28; H04L 12/14

(52) U.S. Cl. CPC H04L 12/2807; H04L 12/1432

(57) ABSTRACT

An application reception unit receives, via a first terminal, an authority application, an approval confirmation unit confirms to a second terminal whether to approve the authority application, an authority management unit that manages an authority to the first terminal, the authority management unit is to, when the authority application is approved, give an authority to the first terminal, a control management unit, when an authority to apply to the first terminal is given, changes an elevator operation setting based on the authority application, a traffic volume calculating unit refers to an elevator operation setting database storing operation setting information indicating a setting related to operation for each elevator and calculates a traffic volume for each elevator, a charge amount calculating unit calculates a charge amount for each of the applicants, and a presentation information generating unit outputs the presentation information to the first terminal or the second terminal.

### CROSS-REFERENCE TO RELATED APPLICATIONS

The present application is a continuation of International Application No. PCT/JP2022/035556, filed Sep. 26, 2022, which claims priority from PCT/JP2021/047791, filed Dec. 23, 2021, the entire contents of each are incorporated herein by reference.

### TECHNICAL FIELD

The present disclosed technology relates to a management technique for managing information for tenant management.

### BACKGROUND ART

Conventionally, for example, Patent Literature 1 discloses that a tenant can change a setting of a use schedule or the like for equipment dedicated for each tenant. Specifically, Patent Literature 1 describes that “By requesting display of a charging status of a specified fee from a tenant terminal which is provided by building management and can turn on/off air conditioning and lighting equipment for each tenant, schedule operation reservation, extension reservation, and temperature setting, a current usage accumulation value (current value) of an object corresponding to the request is read, and from the read current value and a previous total usage amount (previous meter reading value) read from a usage amount management file storing data at the time of previous fee billing, a usage amount and a usage fee from a reference fixed date and time to the time of request occurrence are output to the tenant terminal.”.

### CITATION LIST

### Patent Literature

Patent Literature 1: JP H05-054038 A

### SUMMARY OF INVENTION

### Technical Problem

However, in recent years, usage modes of tenants have been diversified. The tenant terminal in Patent Literature 1 has a problem that it tends to be difficult to change the setting suitable for the usage mode of the tenant.

The present disclosure has been made to solve the above problems, and an object of the present disclosure is to provide a management device that enables a terminal for a tenant to change a setting suitable for a usage mode of a tenant even in a situation where the usage mode of the tenant is diversified.

### Solution to Problem

A management device of the present disclosure includes: processing circuitry to perform:
to receive, via a first terminal, an authority application indicating that an authority to make an operation setting related to an elevator provided in the facility has been requested from a facility user who is an applicant, or an operation setting application including a content of the operation setting of the elevator provided in the facility;
to confirm to a second terminal whether or not to approve the authority application received;
to manage an authority of the operation setting application to the first terminal, the processing circuitry being configured to, when receiving approval information indicating approval of the authority application from the second terminal, give an authority to the first terminal that has requested the authority;
to, when an authority to apply for the operation setting to the first terminal is given, change a setting related to the operation of the elevator on a basis of the operation setting application received from the first terminal;
to refer to an elevator operation setting database storing operation setting information indicating a setting related to operation for each elevator and calculate a traffic volume for each elevator;
to calculate a charge amount for each of the applicants using the traffic volume calculated; and
to generate presentation information by using the charge amount for each of the applicants calculated and output the presentation information to the first terminal or the second terminal.

### Advantageous Effects of Invention

Since the present disclosure is configured as described above, it is possible to provide a management device that enables a setting change suitable for a tenant usage form from a terminal for a tenant even in a situation where the tenant usage form is diversified.

### BRIEF DESCRIPTION OF DRAWINGS

FIG. 1 is a diagram illustrating a management device according to a first embodiment of the present disclosure and a management system including the management device.

FIG. 2 is a diagram illustrating an example of a database included in a database unit according to the present disclosure.

FIG. 3 is a flowchart illustrating an example of authority change processing in the management device according to the present disclosure.

FIG. 4 is a flowchart illustrating an example of control setting processing in the management device according to the present disclosure.

FIG. 5 is a diagram illustrating a first configuration example of a management device according to a second embodiment of the present disclosure and a management system including the management device.

FIG. 6 is a diagram illustrating a second configuration example of the management device according to the second embodiment of the present disclosure and the management system including the management device.

FIG. 7 is a diagram illustrating a second example of a database included in a database unit according to the present disclosure.

FIG. 8 is a flowchart illustrating an example of processing in the management device according to the second embodiment of the present disclosure.

FIG. 9 is a diagram illustrating a concept of information managed by the management device according to the second embodiment.

FIG. 10 is a diagram illustrating a first configuration example of a management device according to a third embodiment of the present disclosure and a management system including the management device.

FIG. 11 is a diagram illustrating a second configuration example of the management device according to the third embodiment of the present disclosure and the management system including the management device.

FIG. 12 is a flowchart illustrating an example of processing in the management device according to the third embodiment of the present disclosure.

FIG. 13 is a diagram illustrating an example of a configuration of a first terminal.

FIG. 14 is a flowchart illustrating an example of processing in the first terminal.

FIG. 15 is a diagram illustrating an example of a configuration of a second terminal.

FIGS. 16A, 16B, and 16C are diagrams each illustrating a concept of an image presented by the management device according to the third embodiment.

FIG. 17 is a view for describing a concept of an image presented by the management device according to the third embodiment.

FIGS. 18A and 18B are diagrams each illustrating a concept of an image presented by the management device according to the third embodiment.

FIG. 19 is a diagram illustrating a first configuration example of a management device according to a fourth embodiment of the present disclosure and a management system including the management device.

FIG. 20 is a diagram illustrating a second configuration example of the management device according to the fourth embodiment of the present disclosure and the management system including the management device.

FIG. 21 is a flowchart illustrating an example of processing in the management device according to the fourth embodiment of the present disclosure.

FIG. 22 is a diagram illustrating a first configuration example of a management device according to a fifth embodiment of the present disclosure and a management system including the management device.

FIG. 23 is a diagram illustrating a second configuration example of the management device according to the fifth embodiment of the present disclosure and the management system including the management device.

FIG. 24 is a flowchart illustrating an example of processing in the management device according to the fifth embodiment of the present disclosure.

FIG. 25 is a view for describing a concept of an image presented by the management device according to the fifth embodiment.

FIG. 26 is a view for describing a concept of an image presented by the management device according to the fifth embodiment.

FIG. 27 is a view for describing a concept of an image presented by the management device according to the fifth embodiment.

FIG. 28 is a diagram illustrating a first example of a hardware configuration for implementing functions according to the present disclosure.

FIG. 29 is a diagram illustrating a second example of a hardware configuration for implementing the functions according to the present disclosure.

### DESCRIPTION OF EMBODIMENTS

In order to explain the present disclosure in more detail, embodiments for carrying out the present disclosure will be described below with reference to the accompanying drawings.

### First Embodiment

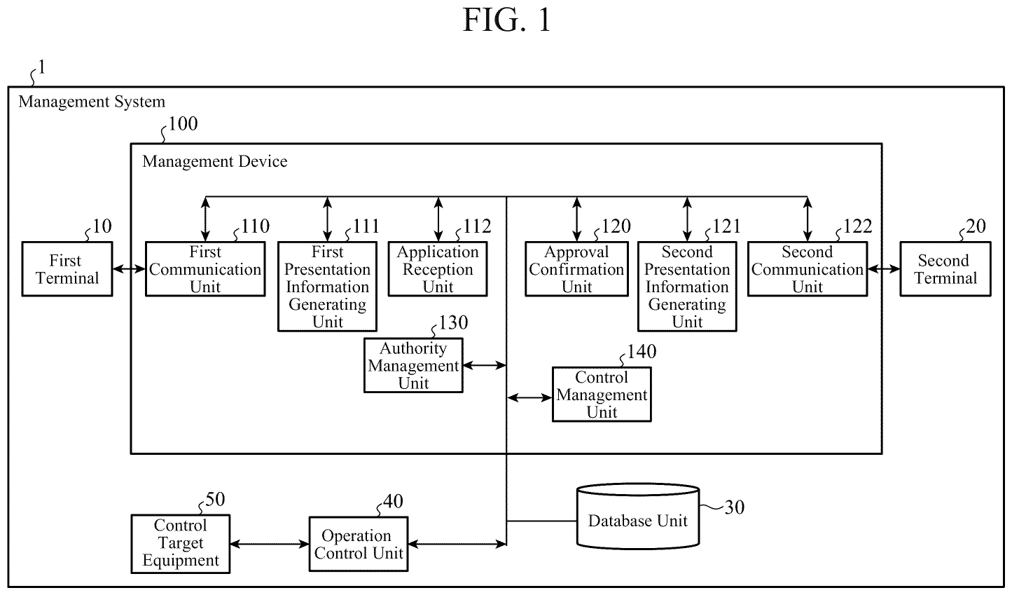

FIG. 1 is a diagram illustrating a management device 100 according to a first embodiment of the present disclosure and a management system 1 including the management device 100.

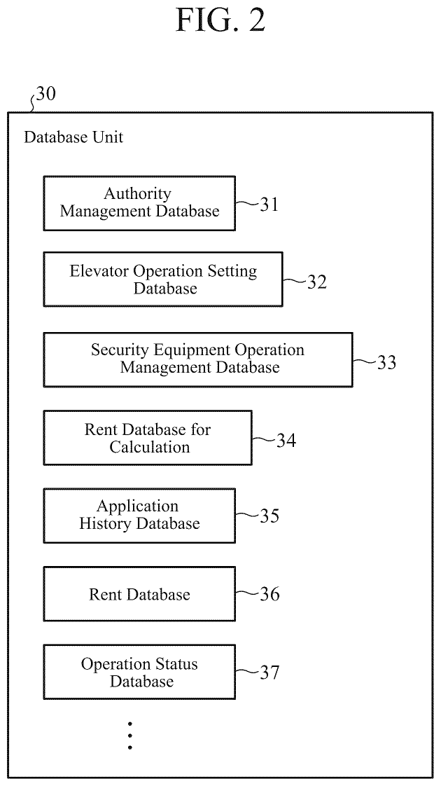

FIG. 2 is a diagram illustrating an example of a database included in a database unit 30 according to the present disclosure.

The management system 1 is a system that manages setting information related to use of a facility.

The management system 1 is a system that manages information regarding equipment used by facility users such as a tenant of a facility, a distribution company that performs distribution inside the facility, an employee of the facility, and a visitor of the facility.

In the conventional technology, there is no technology that enables operation setting of an elevator which is equipment of a facility from a terminal for a facility user such as a tenant. Therefore, in each of the following embodiments, an example in which the operation setting of the elevator is enabled by an application from the facility user via the terminal will be described.

The management system 1 illustrated in FIG. 1 includes a first terminal 10, a second terminal 20, a database unit 30, a management device 100, an operation control unit 40, and a control target equipment 50. However, the management system 1 of the present disclosure only needs to include at least the management device 100, and one or more of the configurations other than the management device 100 may be an external device.

The first terminal 10 is a terminal owned by an applicant (also referred to as a facility user) who makes an application to the management device.

The first terminal 10 presents an image so that the user who is an applicant can select or input the application content.

The first terminal 10 is configured to be able to transmit, to the management device 100, an application content that the user who is an applicant wants to apply for.

The first terminal 10 is, for example, a terminal lent by a facility manager for each user, and includes a plurality of terminals in a case where there are a plurality of users in the same facility. In this case, the plurality of first terminals 10 have user identification information that can be identified at least for each user.

Note that the first terminal 10 may be provided with application software for implementing the above functions.

The first terminal in a case where the applicant is a tenant will be described.

The first terminal 10 is a terminal for a tenant.

The first terminal 10 presents an image so that the application content can be selected or input.

The first terminal 10 is configured to be able to transmit the application content the tenant desires to apply for to the management device 100.

The first terminal 10 is, for example, a terminal lent by a facility manager for each tenant, and includes a plurality of terminals in a case where a plurality of tenants are resident in the same facility. In this case, the plurality of first terminals 10 have user identification information that can be identified at least for each tenant.

The second terminal 20 is a terminal for a facility manager. The facility manager manages the facility, and is a person who charges the user and receives the charged money. In a case where the user is a tenant, the facility manager may be a facility manager who directly receives the rent from the tenant, or may be a facility manager who receives the rent from the tenant as the management operation. In addition, the facility manager may be a facility owner.

The second terminal 20 presents whether to approve the application content from the first terminal 10 (a terminal of a user who is a facility user such as a tenant) in a selectable or inputtable manner.

In addition, the second terminal 20 presents the data stored in the database unit 30 with reference to the database unit 30 in response to a presentation request by the operator of the second terminal 20.

Note that the second terminal 20 may be provided with application software for implementing the above functions.

The database unit 30 stores data used for processing in the management device 100.

In addition, the database unit 30 stores data used for controlling the elevator.

The database included in the database unit 30 will be described.

The database unit 30 includes, for example, an authority management database 31, an elevator operation setting database 32, a security equipment operation management database 33, a rent database for calculation 34, an application history database 35, a rent database 36, an operation status database 37, and the like illustrated in FIG. 2.

Note that the database unit 30 illustrated in FIG. 2 includes databases other than the database used in the management device 100 of the first embodiment.

The authority management database 31 is a database that stores information for managing application authority for the user. The authority management database 31 stores whether the authority is given to each user or the authority is returned. The authority management database 31 associates data such as user identification information, application type information, and authority presence/absence information.

The user identification information includes a user name, a user number, output destination information, and the like. The output destination information indicates, for example, a terminal (first terminal) owned or held by the user.

The application type information is “operation setting”, “security equipment operation setting”, “power setting”, and the like. Note that update type information is not necessarily required as long as it is, for example, only “operation setting”.

When the user is a tenant, the authority management database 31 is a database that stores information for managing application authority for the tenant. The authority management database 31 stores whether the authority is given to each tenant or the authority is returned. The authority management database 31 associates data such as tenant identification information, application type information, and authority presence/absence information.

The tenant identification information is a tenant name, a tenant number, and the like.

The elevator operation setting database 32 stores operation setting information regarding the operation of each elevator provided in the facility.

Specifically, the elevator operation setting database 32 associates data such as elevator identification information and operation setting information.

The elevator identification information is, for example, an elevator number for each elevator car in the elevator and a bank number for each group of destination floors.

The operation setting information includes an operation date, an operation time, a stop floor, a use form, and applicant information (If the applicant is a tenant, it is also described as “application tenant information”.).

The operation date is a scheduled operation date.

The operation time is, for example, a time period such as “from AM 8:00 to AM 10:00”, “from AM 10:00 to PM 12:00”, and “from PM 12:00 to PM 14:00”.

The stop floor indicates a level at which the elevator is scheduled to stop in the facility.

The use form indicates a form such as dedicated, stop floor control, priority use, use (normal use), and non-use. Dedicated is a use form in which only a specific facility user can use a specific elevator. The stop floor control is a use form in which a specific elevator can stop only at a specific stop floor. The priority use is a use form in which stop efficiency indicating a stop ratio is higher than that in the normal use.

The applicant information is user identification information indicating the user who has made the operation setting application, and specifically, is a user name, a user number, or the like. More specifically, examples thereof include a tenant name, a tenant number, a company name of a distribution company, a moving company, or the like, an identification number of the company, and a title and a name of an employee. If the user who is an applicant is a tenant, the applicant information is application tenant information. The application tenant information is a tenant name, a tenant number, and the like indicating the tenant who has made the operation setting application.

Note that the elevator operation setting database 32 may have explanatory information regarding the elevator for each elevator. The explanatory information is, for example, information for describing the scale of the elevator car in the elevator such as 24 passenger, 10 passenger, 6 passenger, large, medium, and small.

The security equipment operation management database 33 stores operation setting information for each security equipment regarding operation of the security equipment provided in the facility. Hereinafter, this operation setting information is also referred to as “security equipment operation setting information” in order to be distinguished from the operation setting information of the elevator.

The security equipment is, for example, a security gate provided for each floor or each area divided in each floor.

Specifically, the security equipment operation management database 33 associates data such as security facility identification information and security facility operation setting information.

The security equipment identification information is a security equipment number or the like that can be identified for each security equipment.

The security equipment operation setting information includes an operation date, an operation time, an installation position, a use form, and applicant information (application tenant information).

The operation date, the operation time, and the applicant (application tenant) are similar to the operation setting information of the elevator described above.

The installation position is a level (1st floor, 2nd floor, 3rd floor . . . ) in which the security equipment is installed in the facility, a position for each area in the facility used by the applicant, a position for each tenant, and the like.

The use form indicates a form such as use or non-use.

The applicant information is user identification information indicating the user who has made the operation setting application, and specifically, is a user name, a user number, or the like. More specifically, examples thereof include a tenant name, a tenant number, a company name of a distribution company, a moving company, or the like, an identification number of the company, and a title and a name of an employee. If the user who is an applicant is a tenant, the applicant information is application tenant information. The application tenant information is a tenant name and a tenant number indicating a tenant for which the security equipment operation setting has been performed.

The rent database for calculation 34 includes information for calculating a rent corresponding to the operation setting information of the elevator or the security equipment operation setting information. Specifically, in a case where the user who is the applicant is a tenant, the rent database for calculation 34 has, for example, information indicating an increase amount or a decrease amount of the rent corresponding to the application authority, the priority use or non-use of the elevator, the utilization rate of the elevator, the use or non-use of the security equipment, and the like on the basis of the rent for the tenant without the application authority and in a case of normally using the elevator.

If the user who is the applicant includes a person other than the tenant, the rent is the charge amount.

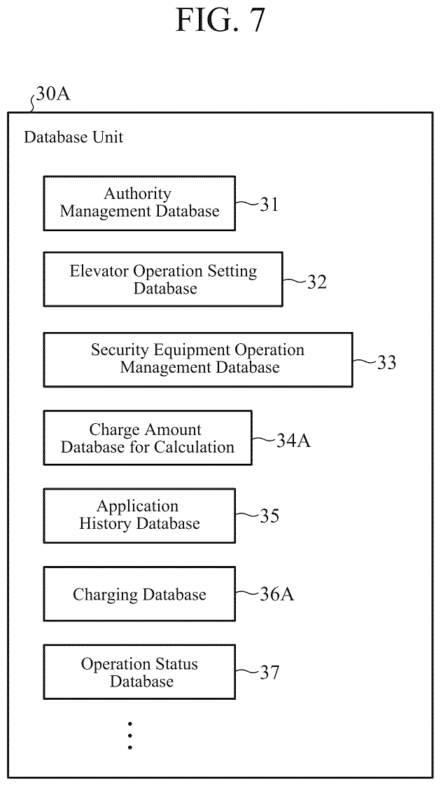

When charging is performed separately from the rent, the rent database for calculation 34 may be a charge amount database for calculation (see FIG. 7) to be described later.

The application history database 35 stores history information of application contents from a user who is an applicant such as a tenant. The application history database 35 associates application date and time, user identification information (tenant identification information), application type information, application content information, and the like. The application date and time indicate date and time when applied. The details of the user identification information (tenant identification information) are similar to the user identification information (tenant identification information) described above. The application type information is similar to the application type information described above. The application content information indicates details of the applied content.

The rent database 36 stores the rent determined for each tenant.

The rent database 36 associates data such as tenant identification information and rent.

In a case where the user who is the applicant includes a person other than the tenant, the rent data in the rent database 36 may be charging. That is, the rent database 36 may be a charging database (see FIG. 7).

The operation status database 37 stores operation status information indicating the current operation status of the elevator.

The operation status database 37 associates data such as elevator identification information, a current position of the elevator, a speed of the elevator, and a moving direction of the elevator.

The operation status information is updated each time by information from the operation control unit 40 that controls the operation of the elevator.

The operation control unit 40 controls the operation of the control target equipment 50.

The control target equipment 50 is, for example, an elevator installed in a facility for rent to a tenant, an elevator for distribution in the facility, or the like. The elevator includes, for example, an elevator with an elevator car or an escalator.

Specifically, the operation control unit 40 refers to the elevator operation setting database 32, and controls the operation of the elevator using the elevator identification information, the operation setting information, and the date and time information.

The management device 100 manages information regarding equipment used by a tenant of the facility.

The management device 100 is communicably connected to each of the first terminal 10, the second terminal 20, the database unit 30, and the operation control unit 40.

A configuration of the management device 100 will be described.

The management device 100 illustrated in FIG. 1 includes a first communication unit 110, a first presentation information generating unit 111, an application reception unit 112, an approval confirmation unit 120, a second presentation information generating unit 121, a second communication unit 122, an authority management unit 130, a control management unit 140, a control unit (not illustrated), and the like.

The control unit (not illustrated) performs overall control of the management device 100. For example, control such as activation and stop of the management device 100 is performed.

The first communication unit 110 transmits and receives information between the management device 100 and the first terminal 10.

The first presentation information generating unit 111 generates presentation information indicating information to be presented to the first terminal 10 (terminal for facility users including tenants).

The first presentation information generating unit 111 generates presentation information including an operation setting image. The first presentation information generating unit 111 generates an operation setting image corresponding to the application authority possessed by the applicant for each of the applicants (including tenants. Hereinafter, “Applicant” includes a tenant.).

Specifically, when receiving a presentation request including the applicant identification information (tenant identification information) from the first terminal 10 via the first communication unit 110, the first presentation information generating unit 111 refers to the database unit 30, checks the application authority possessed by the applicant, and then acquires the operation setting information to generate the operation setting image.

The operation setting image is, for example, an image for setting the operation of the elevator, and is an image to be presented to the first terminal 10. Specifically, it is an image that presents items corresponding to the application authority possessed by the applicant to be presented in a selectable or inputtable manner among elevator identification information (elevator number, bank number, and the like), a layer number for identifying each floor in the facility, an operation date, an operation time, a stop floor, a use form, and the like.

When the image is held in the application in the first terminal 10, the first presentation information generating unit 111 may generate and output presentation information (presentation command information) for giving a command to display the image in the application.

The application reception unit 112 receives an application from the first terminal 10.

Specifically, the application reception unit 112 receives, from the first terminal 10, which is a terminal for a facility user who is an applicant, an authority application for requesting an authority to make an operation setting related to an elevator provided in the facility, or an operation setting application including a content of the operation setting of the elevator provided in the facility.

The approval confirmation unit 120 confirms to the second terminal 20 whether to approve the application from the first terminal 10.

Specifically, the approval confirmation unit 120 confirms whether or not to approve the authority application received by the application reception unit 112 to the second terminal 20 which is a terminal for a facility manager.

The second presentation information generating unit 121 generates presentation information indicating information to be presented to the second terminal 20 (terminal for facility manager).

The second presentation information generating unit 121 generates presentation information including an operation setting image indicating operation settings for all elevators for each facility.

Specifically, when receiving the operation setting screen presentation request from the second terminal 20 via the second communication unit 122, the second presentation information generating unit 121 refers to the database unit 30 and acquires all pieces of the operation setting information for each facility to generate the operation setting image. The operation setting image includes, for example, an image that enables operation setting for all time periods and all banks (all elevators).

The operation setting image generated by the second presentation information generating unit 121 is, for example, an image that enables an operation such as returning all operation settings to the default settings.

When the image is held in the application in the second terminal 20, the second presentation information generating unit 121 may generate and output presentation information (presentation command information) for giving a command to display the image in the application.

The second communication unit 122 transmits and receives information between the management device 100 and the second terminal 20.

The authority management unit 130 manages authorization or authority return applied from the first terminal 10.

Specifically, the authority management unit 130 is the authority management unit 130 that manages the authority of the operation setting application to the first terminal 10. When the approval confirmation unit 120 receives approval information indicating that the second terminal 20 approves the authority application from the first terminal 10, the authority management unit gives the authority to the first terminal 10 that has requested the authority. In addition, the authority management unit 130 cancels the authorization to the first terminal 10 in response to the application for returning the authority.

More specifically, the authority management unit 130 manages the authority by changing the authority presence/absence information in the authority management database 31 from “absent” to “present” to give the authority, and changing the authority presence/absence information from “present” to “absent” to release the authority.

When the authority to the first terminal 10 is given, the control management unit 140 changes the setting related to the operation of the elevator on the basis of the operation setting application received by the application reception unit 112 from the first terminal 10.

Specifically, when the application reception unit 112 receives the operation setting application from the first terminal 10, the control management unit 140 updates the operation setting database on the basis of the operation setting content indicated in the operation setting application.

In the management device 100 illustrated in FIG. 1, the first communication unit and the second communication unit are separately illustrated, but the first communication unit and the second communication unit may be configured by one communication unit.

Although the first presentation information generating unit 111 and the second presentation information generating unit 121 are separately illustrated in management device 100 in FIG. 1, the first presentation information generating unit 111 and the second presentation information generating unit 121 may be configured by one presentation information generating unit. In this case, one presentation information generating unit generates presentation information for the first terminal 10 or presentation information for the second terminal 20.

Processing executed by the management device 100 according to the present disclosure will be described.

First, authority change processing according to the present disclosure will be described.

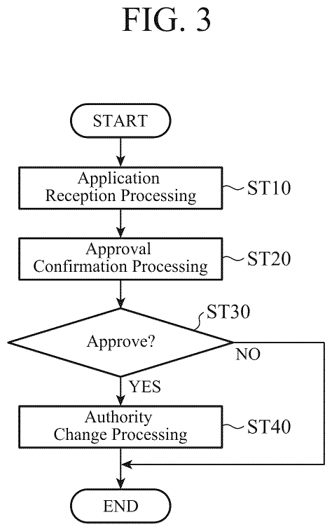

FIG. 3 is a flowchart illustrating an example of authority change processing in the management device 100 according to the present disclosure.

For example, when the change of the authority is requested in the first terminal 10, the management device 100 starts the processing illustrated in FIG. 3.

The application reception unit 112 executes application reception processing (step ST10).

Specifically, the application reception unit 112 receives the authority application from the first terminal 10 via the first communication unit 110, and checks the content of the authority application. The application reception unit 112 acquires the applicant identification information (tenant identification information) included in the authority application. In addition, the application reception unit 112 determines whether the application is an application for authorization or an application for authority return.

In the case of an authorization application, the application reception unit 112 notifies the approval confirmation unit 120 of the authorization application together with the applicant identification information (tenant identification information).

When the application is an application for authority return, the application reception unit 112 notifies the approval confirmation unit 120 of the authorization application together with the applicant identification information (tenant identification information). When the application is an application for authority return, the application reception unit 112 notifies the authority management unit 130 of the authorization application together with the applicant identification information (tenant identification information).

The approval confirmation unit 120 executes approval confirmation processing (step ST20).

The approval confirmation unit 120 confirms whether or not to approve the authority application received by the application reception unit 112 to the second terminal 20 which is a terminal for a facility manager. Specifically, the approval confirmation unit 120 outputs inquiry information for inquiring approval together with the applicant identification information (tenant identification information) to the second terminal 20 via the second presentation information generation unit 121 and the second communication unit 122.

As a result, the second terminal 20 presents a screen for approving the authority application. When the facility manager operates the screen of the second terminal 20, an approval signal indicating approval is output to the management device 100.

The approval confirmation unit 120 determines whether the facility manager has approved the application from the first terminal 10 (terminal for a facility user such as a tenant) (step ST30).

Specifically, the approval confirmation unit 120 waits for a response from the second terminal 20, and when receiving the approval information from the second terminal 20, determines that the facility manager has approved, and notifies the authority management unit 130 that the authority application has been approved.

On the other hand, in a case where the approval confirmation unit 120 receives the non-approval information indicating non-approval or, for example, in a case where the approval information has not been received within a predetermined constant time, the approval confirmation unit determines that the facility manager has not approved (step ST30 “NO”), and notifies the application reception unit 112 of the non-approval. In this case, the application reception unit 112 further outputs information indicating that the authorization application has not been approved to the first terminal 10 via the first presentation information generating unit 111 and the first communication unit 110. Thereafter, the processing illustrated in FIG. 3 ends.

In step ST30, when the approval confirmation unit 120 determines that the facility manager has approved (step ST30 “YES”), the authority management unit 130 executes authority change processing (step ST40).

Specifically, upon receiving the notification of the authority application from the approval confirmation unit 120, the authority management unit 130 updates the authority management database 31 according to the content of the authority application.

In accordance with the content of the authority application, the authority management unit 130 changes the authority presence/absence information in the authority management database 31 from “absent” to “present” to give the authority, and changes the authority presence/absence information from “present” to “absent” to release the authority.

Thereafter, the processing illustrated in FIG. 3 ends.

In this manner, authorization to the applicant (facility user including a tenant) or authority return from the applicant is performed.

Next, operation setting processing according to the present disclosure will be described.

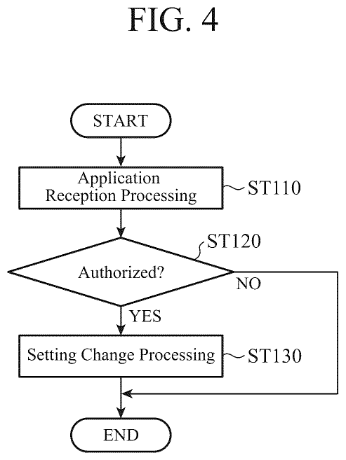

FIG. 4 is a flowchart illustrating an example of operation setting processing in the management device 100 according to the present disclosure.

Upon receiving a signal requesting operation setting from the first terminal 10, the management device 100 starts the processing illustrated in FIG. 4.

The application reception unit 112 executes application reception processing (step ST110).

Specifically, the application reception unit 112 receives the operation setting application.

The application reception unit 112 determines whether the applicant who has applied (facility user including a tenant) has an application authority for the operation setting application (step ST120).

Specifically, the application reception unit 112 refers to the authority management database 31 using the tenant identification information and the operation setting information included in the operation setting application, and determines whether the authority is given.

When the application reception unit 112 determines that the applicant does not have authority (step ST120 “NO”), the flow illustrated in FIG. 4 ends. In this case, before the end, processing of presenting that the applicant does not have authority to perform setting is executed.

If the application reception unit 112 determines that the applicant has authority (step ST120 “YES”), the control management unit 140 executes setting change processing (step ST130).

Specifically, the control management unit 140 updates the elevator operation setting database 32 using the user identification information (tenant identification information) and the operation setting information included in the operation setting application.

At this time, the update history database may also be updated.

When the control management unit 140 updates the elevator operation setting database 32, the processing illustrated in FIG. 4 ends.

In this way, the operation setting is changed by the application using the first terminal 10.

According to the first embodiment, it is possible to execute the operation setting related to the operation of the equipment (for example, the elevator) provided in the facility from the first terminal 10 which is the terminal for the facility user including the tenant.

Further, according to the first embodiment, the content of the operation setting application executed by the facility user including the tenant can be presented to the facility manager via the second terminal 20.

In addition, according to the first embodiment, when the application authority is given to the facility user including the tenant, the operation setting of the elevator and the like can be performed within the range of the given application authority even in a time when the facility manager cannot handle the application (for example, outside business hours), which is advantageous for both the facility user including the tenant and the facility manager.

Further, in the configuration according to the first embodiment, in response to an application from the first terminal 10 which is a terminal for a facility user including a tenant, it is possible to manage the authority of the facility user including the tenant with respect to the operation setting of the shared equipment such as the elevator in the facility. In other words, the facility user including the tenant can change the operation setting of the equipment in the facility using the first terminal 10. In addition, the facility manager can provide a new service called operation setting of the equipment in the facility to the facility user including the tenant.

A management device according to the present disclosure is a management device that manages information regarding equipment used by facility users, and the management device is configured to include: an application reception unit that receives, from a first terminal that is a terminal for facility users, an authority application for requesting an authority to make an operation setting related to an elevator provided in the facility or an operation setting application including a content of the operation setting of the elevator provided in the facility; an approval confirmation unit that confirms whether or not to approve the authority application received by the application reception unit 112 to a second terminal that is a terminal for a facility manager; an authority management unit that manages an authority of the operation setting application to the first terminal, the authority management unit giving, when the approval confirmation unit receives approval information indicating that the authority application is approved from the second terminal, an authority to the first terminal that has requested the authority; and a control management unit that, when the authority of the operation setting application to the first terminal is given, changes a setting related to operation of the elevator on the basis of the operation setting application received by the application reception unit from the first terminal.

As a result, even in a situation where the use form of the tenant is diversified, it is possible to provide a management device that enables setting change suitable for the use form of the tenant from the terminal for the tenant.

A management system according to the present disclosure is a management system that includes: a first terminal that is a terminal for facility users; a second terminal that is a terminal for a facility manager; and a management device capable of communicating with the first terminal and the second terminal, and manages information regarding equipment used by facility users, and the management device is configured to include: an application reception unit that receives, from the first terminal, an authority application for requesting an authority to make an operation setting related to an elevator provided in the facility or an operation setting application including a content of the operation setting of the elevator provided in the facility; an approval confirmation unit that confirms whether or not to approve the authority application received by the application reception unit to the second terminal; an authority management unit that manages an authority of the operation setting application to the first terminal, the authority management unit giving, when the approval confirmation unit receives approval information indicating that the authority application is approved from the second terminal, an authority to the first terminal that has requested the authority; and a control management unit that, when the authority of the operation setting application to the first terminal is given, changes a setting related to operation of the elevator on the basis of the operation setting application received by the application reception unit from the first terminal.

As a result, even in a situation where the use form of the facility user is diversified, it is possible to provide a management system that enables setting change suitable for the use form of the facility user from the terminal for the facility users.

A management method according to the present disclosure is a management method for managing information regarding equipment used by facility users, and the management method is configured to include: an application reception step of receiving, by an application reception unit, from a first terminal that is a terminal for facility users, an authority application for requesting an authority to make an operation setting related to an elevator provided in the facility, or an operation setting application including a content of the operation setting of the elevator provided in the facility; an approval confirmation step of confirming, by an approval confirmation unit, to a second terminal that is a terminal for a facility manager, whether or not to approve the authority application received by the application reception unit; an authority management step of managing, by an authority management unit, an authority of the operation setting application to the first terminal, the authority management step being configured to, when the approval confirmation unit receives approval information indicating approval of the authority application from the second terminal, give an authority to the first terminal that has requested the authority; and a control management step of changing, by a control management unit, when an authority to apply for the operation setting to the first terminal is given, a setting related to the operation of the elevator on the basis of the operation setting application received by the application reception unit 112 from the first terminal.

As a result, even in a situation where the use form of the facility user is diversified, it is possible to provide a management method that enables a setting change suitable for the use form of the facility user from the terminal for the facility user.

### Second Embodiment

In the first embodiment, an embodiment has been described in which the authority of a tenant is managed with respect to operation setting of equipment in a facility in response to an application from the first terminal 10 which is a terminal for a facility user such as a tenant.

The second embodiment is an embodiment in which charging information regarding a charge amount such as a rent according to an operation setting set by an applicant who is a facility user such as a tenant is presented to the applicant.

The second embodiment includes the configuration already described in the first embodiment in order to illustrate an embodiment in which a function is added in addition to the first embodiment. In the second embodiment, the description of the configuration already described in the first embodiment will be appropriately omitted.

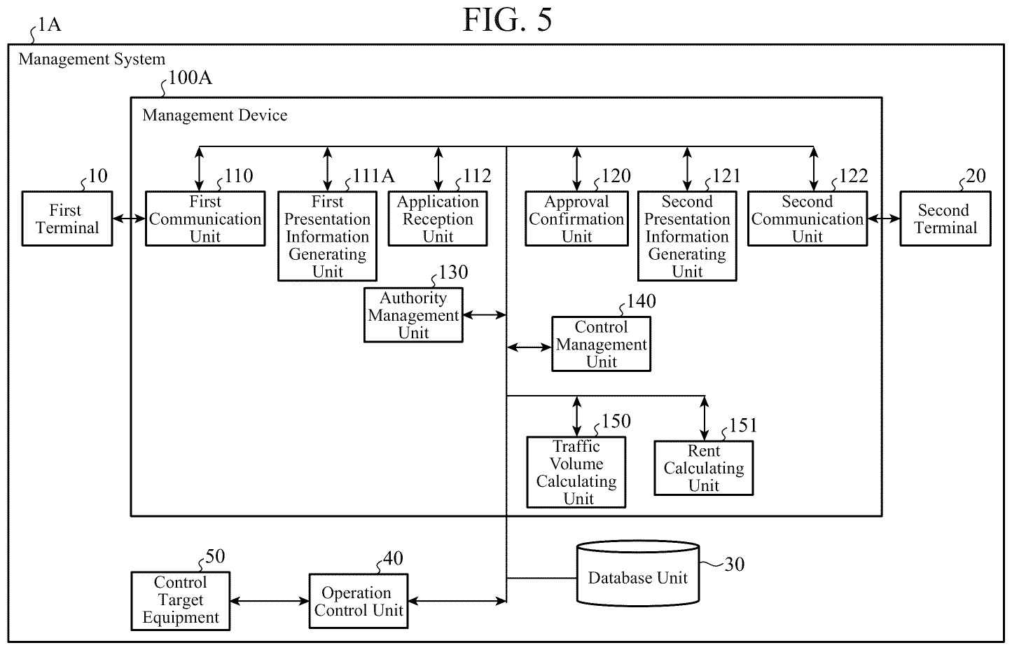

FIG. 5 is a diagram illustrating a first configuration example of a management device 100A according to the second embodiment of the present disclosure and a management system 1A including the management device.

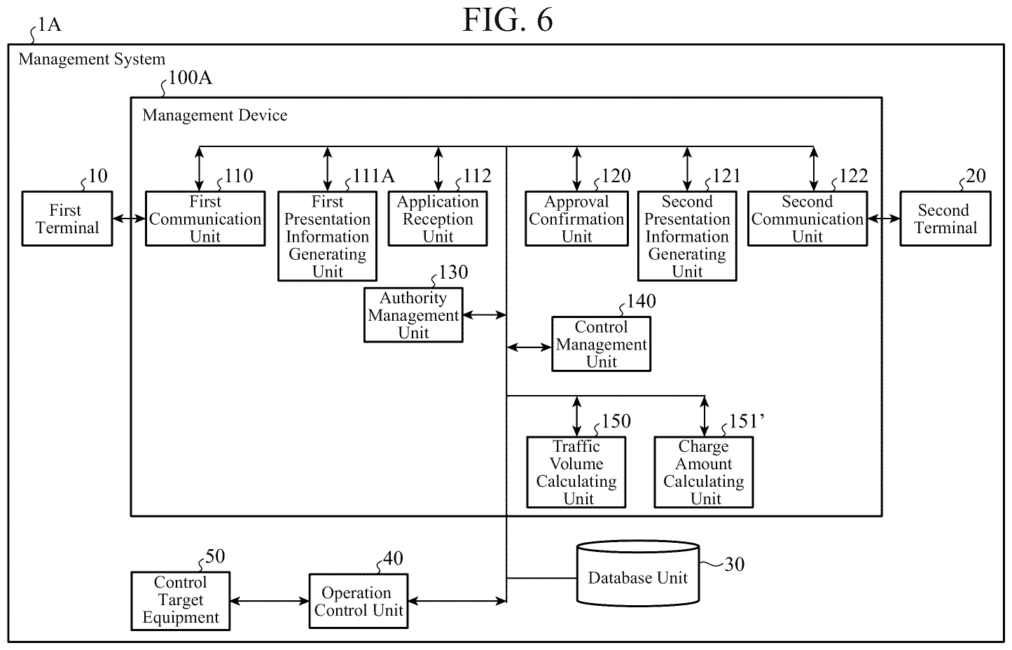

FIG. 6 is a diagram illustrating a second configuration example of the management device 100A according to the second embodiment of the present disclosure and the management system 1A including the management device.

FIG. 7 is a diagram illustrating a second example of the database included in the database unit according to the present disclosure.

The management system 1A is configured to include a first terminal 10, a second terminal 20, a database unit 30, an operation control unit 40, a control target equipment 50, and a management device 100A.

Each of the first terminal 10, the second terminal 20, the database unit 30, the operation control unit 40, and the control target equipment 50 has a configuration similar to the configuration illustrated in FIG. 1, and the detailed description thereof will be omitted here.

A database unit 30A illustrated in FIG. 7 includes a charge amount database for calculation 34A and a charging database 36A.

The charge amount database for calculation 34A includes information for calculating a charge amount according to the operation setting information of the elevator or the security equipment operation setting information. Specifically, for example, the charge amount database for calculation 34A has information indicating an increase amount or a decrease amount of the charge amount according to the application authority, the priority use or the non-use of the elevator, the utilization rate of the elevator, the use or the non-use of the security equipment, and the like, on the basis of the charge amount for the user without the application authority and in the case of using the elevator normally. In addition, the charge amount database for calculation 34A has information indicating a reference charge amount in a time unit with respect to the type of the elevator.

The charging database 36A stores charging information related to a charge amount determined for each user who is an applicant.

The charging database 36A associates data such as user identification information and a charge amount.

The management device 100A includes a first communication unit 110, a first presentation information generating unit 111A, an application reception unit 112, an approval confirmation unit 120, a second presentation information generating unit 121, a second communication unit 122, an authority management unit 130, a control management unit 140, a traffic volume calculating unit 150, a rent calculating unit 151 (alternatively, the charge amount calculating unit 151′), a control unit (not illustrated), and the like.

That is, the management device 100A further includes a traffic volume calculating unit 150 and a rent calculating unit 151 (alternatively, the charge amount calculating unit 151′) as compared with the management device 100 illustrated in FIG. 1.

The control unit (not illustrated) performs overall control of the management device 100A. For example, control such as activation and stop of the management device 100 is performed.

Each of the first communication unit 110, the application reception unit 112, the approval confirmation unit 120, the second presentation information generating unit 121, the second communication unit 122, the authority management unit 130, and the control management unit 140 has a configuration similar to the configuration illustrated in FIG. 1, and the detailed description thereof will be omitted here.

The traffic volume calculating unit 150 refers to the elevator operation setting database 32 that stores operation setting information indicating settings related to operation for each elevator, and calculates the traffic volume of the elevator.

The traffic volume of the elevator can be calculated in units of operation setting using data obtained from the elevator operation setting database 32.

The traffic volume of the elevator is represented by the number of people that can be transported, for example, for each elevator and for each date and time (time period). The traffic volume has a large numerical value in the case of a large elevator car, and has a small numerical value in the case of a small elevator car. In addition, when the use form is set to “priority use”, the transportation efficiency increases, and thus the numerical value of the traffic volume increases.

The rent calculating unit 151 calculates a rent or a management cost for each applicant (tenant) using the traffic volume calculated by the traffic volume calculating unit 150.

Specifically, the rent calculating unit 151 calculates the rent by increasing or decreasing only the rent (increase/decrease target rent) at a ratio determined for each tenant in the entire rent of the tenant according to the transportation efficiency for each tenant using the traffic volume.

Alternatively, the rent calculating unit 151 calculates the management cost by increasing or decreasing only the management cost (increase/decrease target management cost) at a ratio determined for each tenant in the entire management cost of the tenant according to the transportation efficiency for each tenant using the traffic volume.

In a case where the applicant is a facility user other than the tenant, the rent calculating unit 151 is replaced with a charge amount calculating unit 151′.

The charge amount calculating unit 151′ calculates the charge amount for each applicant (facility user including a tenant) using the traffic volume calculated by the traffic volume calculating unit 150.

Specifically, the charge amount calculating unit 151′ calculates the charge amount according to the transportation efficiency for each applicant using the traffic volume. The charge amount calculating unit 151′ may include the configuration of the rent calculating unit 151.

The transportation efficiency is, for example, a ratio between the traffic volume based on the current operation setting of the elevator and the traffic volume expected to increase or decrease due to the operation setting.

The ratio of an increase/decrease target charge (increase/decrease target rent) is a ratio set for each applicant such as a facility, a tenant, and an application company. The ratio is set depending on, for example, whether the facility is an upper layer, a middle layer, or a lower layer. The ratio is set depending on, for example, whether the applicant is a tenant resident in the facility or an external company. In addition, for example, the ratio is set depending on whether the use frequency of the elevator is high, medium, or low in the type of the applicant determined in advance for each applicant. Note that when the applicant is an external company, it can be said that the use is by a third party that is not incorporated in the facility-side traffic volume calculation. Therefore, when the applicant is an external company, the ratio of the increase/decrease target charge may be set high regardless of the degree of use frequency.

The ratio of the increase/decrease target charge is stored in, for example, the rent database 36 or the charging database 36A.

A specific example will be described.

An example in which the ratio between the traffic volume based on the current operation setting of the elevator and the traffic volume expected to increase or decrease due to the operation setting is 150% compared to the current time will be described.

The ratio of the increase/decrease target charge is set to ¼ (25%) with respect to the entire charge amount (the entire rent or the entire management cost).

In this case, the total charge amount (the entire rent or the entire management cost) increases by 150% from ¼ (25%) of the total charge amount (the entire rent or the entire management cost), and the total charge amount (the entire rent or the entire management cost) increases by 12.5% from the current total charge amount (the entire rent or the entire management cost) (0.25*1.50+0.75=1.125).

An example in which the ratio between the traffic volume based on the current operation setting of the elevator and the traffic volume expected to increase or decrease due to the application by the external company is 70% compared to the current time will be described.

The ratio of the increase/decrease target cost is set to ¼ (25%) with respect to the entire charge amount (the entire rent or the entire management cost).

In this case, it is a decrease of 70% from ¼ (25%) of the total charge amount (the entire rent or the entire management cost), and a cost reduction of 0.075% from the current total charge amount (the entire rent or the entire management cost) ((0.25*0.70+0.75)-1=−0.075). In the cost reduction, an amount of money that can be reduced to each company and tenant in the facility is charged to the external company.

In addition, the charge amount calculating unit 151′ may further calculate the charge amount (rent, management cost, or usage) for each applicant in consideration of the target charge amount of the entire facility set in advance by the facility manager.

The first presentation information generating unit 111A is obtained by adding a function to the first presentation information generating unit 111 illustrated in FIG. 1.

The first presentation information generating unit 111A generates presentation information for the first terminal 10 by using the charge amount (“Tenant Rent” if the applicant is a tenant) calculated by the charge amount calculating unit 151′ (rent calculating unit 151), and outputs the presentation information to the first terminal 10.

Processing in the management device 100A will be described.

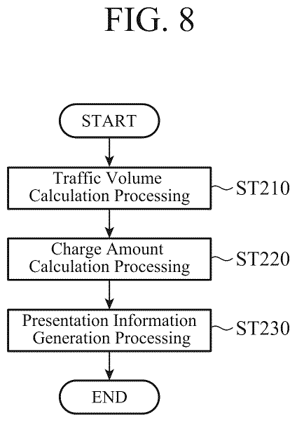

FIG. 8 is a flowchart illustrating an example of processing in the management device 100A according to the second embodiment of the present disclosure.

When operation is performed on the operation setting application screen in the first terminal 10, the management device 100A starts the processing illustrated in FIG. 8.

When acquiring the operation setting information from the first terminal 10, the traffic volume calculating unit 150 executes traffic volume calculation processing (step ST210).

Specifically, the traffic volume calculating unit 150 acquires the operation setting information and information included in the elevator operation setting database 32 by referring to the elevator operation setting database 32 in the database unit 30, and calculates a traffic volume (current traffic volume) based on the current operation setting information and a traffic volume based on the operation setting information (changed traffic volume) acquired from the first terminal 10.

Next, the rent calculating unit 151 executes rent calculation processing (step ST220).

The rent calculating unit 151 acquires the current traffic volume and the changed traffic volume, and calculates the rent using the current traffic volume and the changed traffic volume.

In the case of the configuration including the charge amount calculating unit 151′, the charge amount calculating unit 151′ executes charge amount calculation processing (step ST220).

The charge amount calculating unit 151′ acquires the current traffic volume and the changed traffic volume, and calculates the charge amount using the current traffic volume and the changed traffic volume.

Next, the first presentation information generating unit 111A executes presentation information generation processing (step ST230).

Specifically, the first presentation information generating unit 111A acquires the current traffic volume, the changed traffic volume, and the rent from the rent calculating unit 151, and generates presentation information including a rent image indicating the rent on the basis of the current traffic volume, the changed traffic volume, and the rent. The first presentation information generating unit 111A outputs the generated presentation information to the first terminal 10 via the first communication unit 110.

In the case of the configuration including the charge amount calculating unit 151′, the first presentation information generating unit 111A acquires the current traffic volume, the changed traffic volume, and the charge amount from the charge amount calculating unit 151′, and generates presentation information including a charge amount image indicating the charge amount on the basis of the current traffic volume, the changed traffic volume, and the charge amount. The first presentation information generating unit 111A outputs the generated presentation information to the first terminal 10 via the first communication unit 110.

According to the configuration of the second embodiment, the charge amount such as the rent can be presented on the first terminal 10 according to the content of the operation setting set using the first terminal 10 that is the terminal for the facility user who is the applicant.

After the first presentation information generating unit 111A executes the presentation information generation processing, the processing illustrated in FIG. 8 ends.

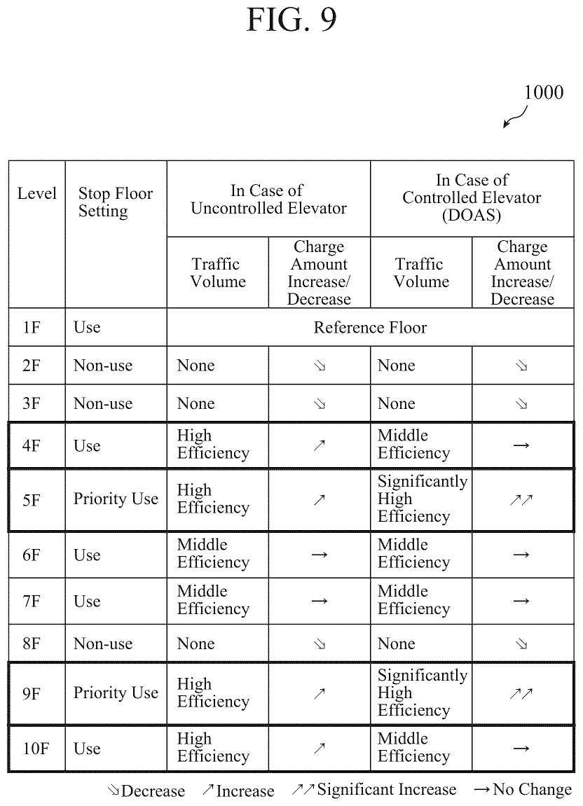

FIG. 9 is a diagram illustrating a concept of management information 1000 managed by the management device 100A according to the second embodiment.

The management information 1000 illustrated in FIG. 9 is information obtained using data of the elevator operation setting database 32.

The management information 1000 indicates, in a certain facility (building), a traffic volume (stop efficiency) of the elevator and a house rent increase/decrease for each level in a state where the stop floor of the elevator is set by the applicant of each level. In addition, in the management information 1000, the traffic volume and the house rent increase/decrease are illustrated for each of a case of an elevator which is not controlled by a destination oriented allocation system (DOAS) and a case of an elevator which is controlled by the DOAS.

In the case of an uncontrolled elevator other than the DOAS, a bank in which a car is stopped at the nearest floor is designated to a floor to be preferentially used, and the car is preferentially sent.

On the other hand, in the case of the DOAS-controlled elevator, since the vertical movement can be flexibly set even for the cars in the same bank, it is possible to increase the priority of the stop floor by preferentially sending the car stopped at the nearest floor without designating the bank.

Therefore, in the case where the DOAS-uncontrolled elevator and the DOAS-controlled elevator are mixedly used, there is a difference in whether or not the priority use of the stop floor setting can be supported, and in the house rent increase/decrease associated therewith.

As indicated by the management information 1000, even when the same level and the same stop floor are set, there is a difference in the increase/decrease in the traffic volume and the house rent between the DOAS-uncontrolled elevator and the DOAS-controlled elevator.

In the case of the DOAS-controlled elevator, it is possible to set the traffic volume and house rent increase/decrease according to the stop floor setting. However, the DOAS-uncontrolled elevator may unintentionally increase the efficiency or may not increase the efficiency at some floors depending on conditions.

For example, on the fourth or tenth floor for which “use” is set, the DOAS-controlled elevator can be set to stop the car at the nearest floor in the traveling direction in which the elevator is operating, instead of stopping the car in the order of level. Therefore, it is possible to send the car with the same efficiency as other use setting floor, and no house rent increase/decrease occurs (For example, it is possible to perform control to send the car in the order of the fourth floor→the sixth floor→the fifth floor→the first floor in the specific bank.).

On the other hand, in the case of the DOAS-uncontrolled elevator, since the elevator is sent in the order of the level, the efficiency increases in the fourth floor (The floor is the upper floor of the second and third floors set as “non-use” and is the lower floor of the fifth floor set as “priority use”.) where there is a high possibility that there is a car stopping at the nearest floor, and in the tenth floor to which a car without a person is always sent because the tenth floor is on the top floor even if the priority use setting is not performed, leading to an increase in the house rent.

In addition, in a case where the standard stop floors are set for the fifth and ninth floors for which “priority use” is set, in the case of a controlled elevator, the efficiency can be greatly increased by the control of operating the car of a specific bank in the vicinity of the fifth or ninth floor, but in the case of an uncontrolled elevator, all the bank cars may leave the fifth or ninth floor depending on the situation, and it is difficult to increase the efficiency.

A management device according to the present disclosure is a management device that manages a setting related to use of a facility, and the management device includes:
an application reception unit to receive, via a first terminal, an authority application indicating that an authority to make an operation setting related to an elevator provided in the facility has been requested from a facility user who is an applicant, or an operation setting application including a content of the operation setting of the elevator provided in the facility;
an approval confirmation unit to confirm to a second terminal whether or not to approve the authority application received by the application reception unit;
an authority management unit to manage an authority of the operation setting application to the first terminal, the authority management unit being configured to, when the approval confirmation unit receives approval information indicating approval of the authority application from the second terminal, give an authority to the first terminal that has requested the authority;
a control management unit to, when an authority to apply for the operation setting to the first terminal is given, change a setting related to the operation of the elevator on a basis of the operation setting application received by the application reception unit from the first terminal;
a traffic volume calculating unit to refer to an elevator operation setting database storing operation setting information indicating a setting related to operation for each elevator and calculate a traffic volume for each elevator;
a charge amount calculating unit to calculate a charge amount for each of the applicants using the traffic volume calculated by the traffic volume calculating unit; and
a presentation information generating unit to generate presentation information by using the charge amount for each of the applicants calculated by the charge amount calculating unit and output the presentation information to the first terminal or the second terminal.

As a result, there is an effect that it is possible to provide a management device that enables a setting change suitable for the use form using the terminal even in a situation where the use form of the facility user (the facility user including the tenant) who is the applicant is diversified.

In addition, it is possible to present a charge amount corresponding to the operation setting application from the facility user.

A management system according to the present disclosure is a management system including: a first terminal that is a terminal for a facility user, a second terminal that is a terminal for a facility manager, and a management device capable of communicating with the first terminal and the second terminal, and managing a setting related to use of a facility, and the management device includes:
an application reception unit to receive, via the first terminal, an authority application indicating that an authority to make an operation setting related to an elevator provided in the facility has been requested from the facility user who is an applicant, or an operation setting application including a content of the operation setting of the elevator provided in the facility;
an approval confirmation unit to confirm to the second terminal whether or not to approve the authority application received by the application reception unit;
an authority management unit to manage an authority of the operation setting application to the first terminal, the authority management unit being configured to, when the approval confirmation unit receives approval information indicating approval of the authority application from the second terminal, give an authority to the first terminal that has requested the authority;
a control management unit to, when an authority to apply for the operation setting to the first terminal is given, change a setting related to the operation of the elevator on a basis of the operation setting application received by the application reception unit from the first terminal;
a traffic volume calculating unit to refer to an elevator operation setting database storing operation setting information indicating a setting related to operation for each elevator and calculate a traffic volume for each elevator;
a charge amount calculating unit to calculate a charge amount for each of the applicants using the traffic volume calculated by the traffic volume calculating unit; and
a presentation information generating unit to generate presentation information by using the charge amount for each of the applicants calculated by the charge amount calculating unit and output the presentation information to the first terminal or the second terminal.

As a result, there is an effect that it is possible to provide a management system that enables a setting change suitable for the use form using the terminal even in a situation where the use form of the facility user (the facility user including the tenant) who is the applicant is diversified.

In addition, it is possible to present a charge amount corresponding to the operation setting application from the facility user.

A management method according to the present disclosure is a management method for managing a setting related to use of a facility, and the management method includes:
an application reception step of receiving, by an application reception unit, via a first terminal, an authority application indicating that an authority to make an operation setting related to an elevator provided in the facility has been requested from an applicant, or an operation setting application including a content of the operation setting of the elevator provided in the facility;
an approval confirmation step of confirming, by an approval confirmation unit, to a second terminal whether or not to approve the authority application received by the application reception unit;
an authority management step of managing, by an authority management unit, an authority of the operation setting application to the first terminal, the authority management step being configured to, when the approval confirmation unit receives approval information indicating approval of the authority application from the second terminal, give an authority to the first terminal that has requested the authority;
a control management step of changing, by a control management unit, when an authority to apply for the operation setting to the first terminal is given, a setting related to the operation of the elevator on a basis of the operation setting application received by the application reception unit from the first terminal;
a traffic volume calculating step of referring to, by a traffic volume calculating unit, an elevator operation setting database storing operation setting information indicating a setting related to operation for each elevator and calculating a traffic volume for each elevator;
a charge amount calculating step of calculating, by a charge amount calculating unit, a charge amount for each of the applicants using the traffic volume calculated by the traffic volume calculating unit; and
a presentation information generating step of generating, by a presentation information generating unit, presentation information by using the charge amount for each of the applicants calculated by the charge amount calculating unit and outputting the presentation information to the first terminal or the second terminal.

As a result, there is an effect that it is possible to provide a management method that enables a setting change suitable for the use form using the terminal even in a situation where the use form of the facility user (the facility user including the tenant) who is the applicant is diversified.

In addition, it is possible to present a charge amount corresponding to the operation setting application from the facility user.

### Third Embodiment

In the second embodiment, in the embodiment (first embodiment) of managing the authority of the facility user such as the tenant with respect to the operation setting of the equipment in the facility, the embodiment of presenting the charge amount of the applicant according to the operation setting set for the facility user who is the applicant to the applicant has been further described.

The third embodiment is an embodiment of presenting a proposal suitable for each facility user.

The third embodiment includes the configuration already described in the first embodiment or the configuration already described in the second embodiment in order to illustrate the embodiment in which a function is added in addition to the first embodiment or the second embodiment. In the third embodiment, the description of the configuration already described in the first embodiment and the second embodiment will be appropriately omitted.

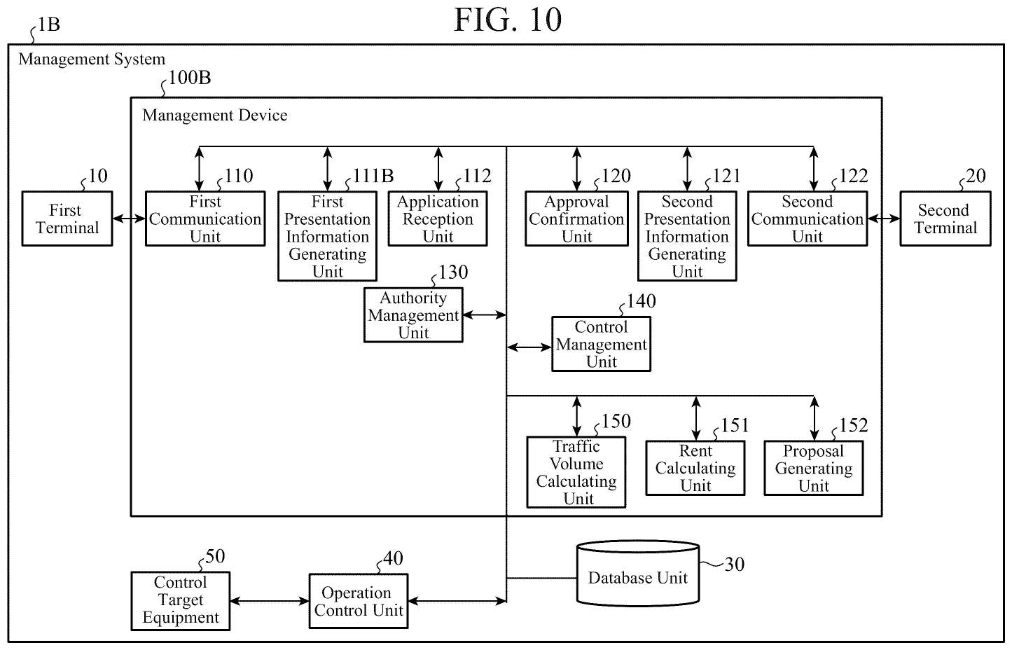

FIG. 10 is a diagram illustrating a first configuration example of a management device 100B according to the third embodiment of the present disclosure and a management system 1B including the management device.

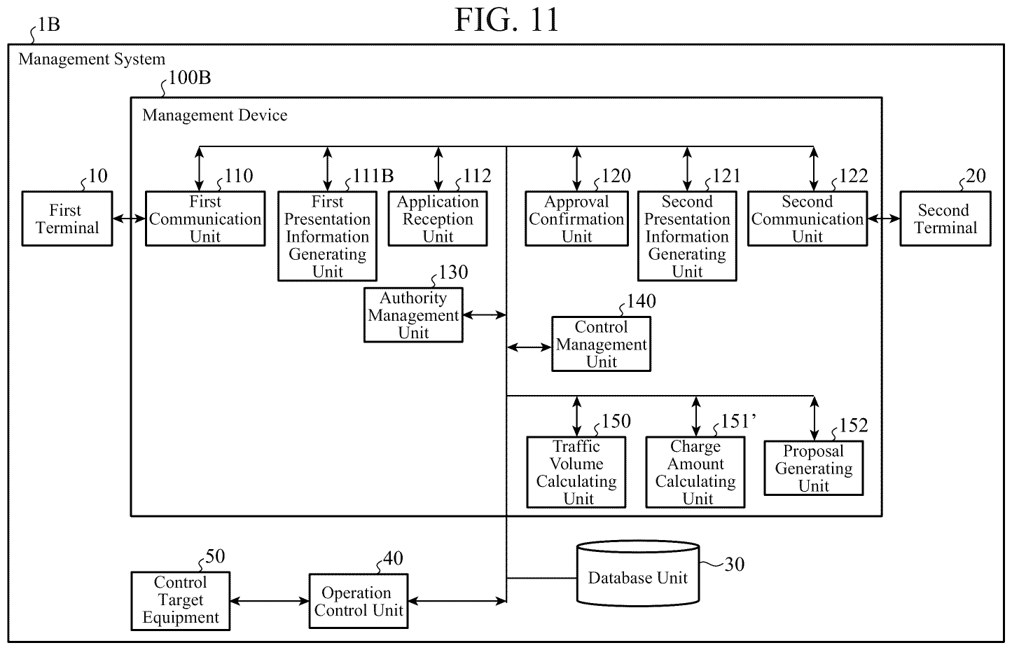

FIG. 11 is a diagram illustrating a second configuration example of the management device 100B according to the third embodiment of the present disclosure and the management system 1B including the management device.

The management system 1B includes a first terminal 10, a second terminal 20, a database unit 30, an operation control unit 40, a control target equipment 50, and a management device 100B.

Each of the first terminal 10, the second terminal 20, the operation control unit 40, and the control target equipment 50 has a configuration similar to the configuration illustrated in FIG. 1, and a detailed description thereof will be omitted here.

Since the database unit 30 is the same as the database unit 30 or the database unit 30A described above, a detailed description of the database unit 30A will be omitted here.

A management device 100B illustrated in FIG. 10 includes a first communication unit 110, a first presentation information generating unit 111B, an application reception unit 112, an approval confirmation unit 120, a second presentation information generating unit 121, a second communication unit 122, an authority management unit 130, a control management unit 140, a traffic volume calculating unit 150, a rent calculating unit 151, a proposal generating unit 152, a control unit (not illustrated), and the like.

A management device 100B illustrated in FIG. 11 includes a first communication unit 110, a first presentation information generating unit 111B, an application reception unit 112, an approval confirmation unit 120, a second presentation information generating unit 121, a second communication unit 122, an authority management unit 130, a control management unit 140, a traffic volume calculating unit 150, a charge amount calculating unit 151′, a proposal generating unit 152, a control unit (not illustrated), and the like.

That is, the management device 100B further includes the proposal generating unit 152 in addition to the management device 100 or the management device 100A.

The management device 100B changes the first presentation information generating unit 111 in the management device 100 or the first presentation information generating unit 111A in the management device 100A to the first presentation information generating unit 111B.

Each of the first communication unit 110, the application reception unit 112, the approval confirmation unit 120, the second presentation information generating unit 121, the second communication unit 122, the authority management unit 130, the control management unit 140, the traffic volume calculating unit 150, and the rent calculating unit 151 has a configuration similar to the configuration illustrated in FIG. 5, and detailed description thereof will be omitted here. In addition, the charge amount calculating unit 151′ has the same configuration as that illustrated in FIG. 6, and the detailed description thereof will be omitted here.

The control unit (not illustrated) performs overall control of the management device 100B. For example, control such as activation and stop of the management device 100B is performed.

The proposal generating unit 152 generates proposal information indicating application contents recommended for each facility user (facility user including a tenant) by using at least one of the traffic volume calculated by the traffic volume calculating unit 150 and the charge amount (alternatively, the rent of the tenant calculated by the rent calculating unit 151) calculated by the charge amount calculating unit 151′.

Specifically, the proposal generating unit 152 refers to the database (for example, the operation setting information database and the charging database 36A (the rent database 36)) in the database unit 30 using the traffic volume and the charge amount, searches for a condition for reducing from the current charge amount (charge amount such as the rent), and generates and outputs the proposal information by using the search result.

The first presentation information generating unit 111B is obtained by adding a function to the first presentation information generating unit 111A illustrated in FIG. 5.

The first presentation information generating unit 111B generates presentation information for the first terminal 10 by using the proposal information generated by the proposal generating unit 152, and outputs the presentation information to the first terminal 10 via the first communication unit 110.

In addition, the first presentation information generating unit 111B refers to the elevator operation setting database 32 storing the operation setting information regarding the operation of each elevator to acquire the current operation setting information, and generates the presentation information including the operation setting image that enables operation for the operation setting application by using the operation setting information.

The second presentation information generating unit 121 may be configured to generate the presentation information similarly to the first presentation information generating unit 111B, and output the presentation information to the second terminal 20 via the second communication unit.

In this case, the management device 100 can also present the proposal content for the facility user such as a tenant to the facility manager via the second terminal 20.

Processing in the management device 100B will be described.

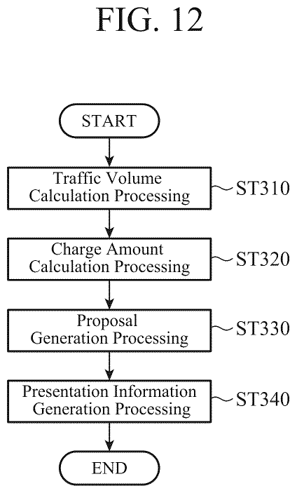

FIG. 12 is a flowchart illustrating an example of processing in the management device 100B according to the third embodiment of the present disclosure.

When operation is performed on the operation setting application screen in the first terminal 10, the management device 100B starts the processing illustrated in FIG. 12.

When the processing illustrated in FIG. 12 is started, the traffic volume calculating unit 150 executes traffic volume calculation processing (step ST310).

Specifically, the traffic volume calculating unit 150 acquires the operation setting information and information included in the elevator operation setting database 32 by referring to the elevator operation setting database 32 in the database unit 30, and calculates a traffic volume (current traffic volume) based on the current operation setting information and a traffic volume based on the operation setting information (changed traffic volume) acquired from the first terminal 10.

Next, the charge amount calculating unit 151′ (rent calculating unit 151) executes charge amount calculation processing (rent calculation processing) (step ST320).

The charge amount calculating unit 151′ (rent calculating unit 151) acquires the current traffic volume and the changed traffic volume, and calculates the charge amount (rent) using the current traffic volume and the changed traffic volume.

Next, the proposal generating unit 152 executes proposal generation processing (step ST330).

The proposal generating unit 152 refers to the database (for example, the operation setting information database and the charging database 36A (the rent database 36)) in the database unit 30 using the traffic volume and the charge amount (rent), searches for a condition for reducing from the current rent, and generates and outputs the proposal information by using the search result.

Next, the first presentation information generating unit 111B executes presentation information generation processing (step ST340).

Specifically, the first presentation information generating unit 111B acquires the current traffic volume, the changed traffic volume, and the charge amount (rent) from the charge amount calculating unit 151′ (rent calculating unit 151). The first presentation information generating unit 111B acquires the proposal information from the proposal generating unit 152. The first presentation information generating unit 111B generates presentation information including a charging information image indicating a charge amount (rent) on the basis of the current traffic volume, the changed traffic volume, the charge amount (rent), and the proposal information. The first presentation information generating unit 111B outputs the generated presentation information to the first terminal 10 via the first communication unit 110.

When the first presentation information generating unit 111B executes the presentation information generation processing, the processing illustrated in FIG. 12 ends.

Here, an example of a configuration of the first terminal 10 and the second terminal 20 will be described.

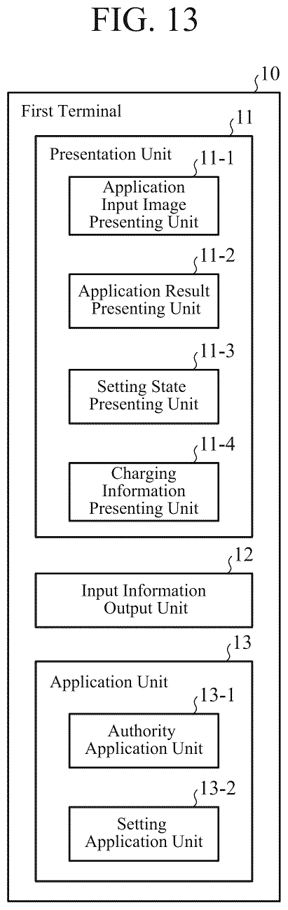

FIG. 13 is a diagram illustrating an example of a configuration of the first terminal 10.

The first terminal 10 illustrated in FIG. 13 includes a presentation unit 11, an input information output unit 12, and an application unit 13.

The presentation unit 11 presents various pieces of presentation information acquired from the management device 100B in a display unit (not illustrated) of the first terminal 10.

The presentation unit 11 includes an application input image presenting unit 11-1, an application result presenting unit 11-2, a setting state presenting unit 11-3, and a charging information presenting unit 11-4.

The application input image presenting unit 11-1 presents an application input image for inputting the contents of the application to the management device by the user who is the applicant.

The application result presenting unit 11-2 acquires an application result from the management device 100B and presents an application result image based on the application result.

The setting state presenting unit 11-3 acquires the setting state information from the management device 100B and presents a setting state image based on the setting state information. The setting state information is temporary setting state information indicating a temporary setting state before the setting application is determined, or determined setting state information indicating a setting state after the setting application is determined. The setting state information includes a setting state set by another applicant.

The charging information presenting unit 11-4 acquires the charging information from the management device 100B and presents a charging information image based on the charging information. The charging information is predicted charge amount information indicating the charge amount before the setting application is determined or determined charge amount information after the setting application is determined.

The input information output unit 12 acquires and outputs information input via the application input image.

In addition, the input information output unit 12 acquires an authority request signal for requesting an application authority via the application input image, for example, and outputs the authority request signal to the management device 100B via the authority application unit 13-1.

In addition, when the content of the setting application is input via the application input image, for example, the input information output unit 12 outputs the content to the management device.

In addition, when acquiring a determination signal indicating that the setting application is determined via the application input image, for example, the input information output unit 12 outputs information (application determination notification) indicating that the application is determined to the management device 100B via the setting application unit 13-2.

That is, the input information output unit 12 outputs the authority request for requesting the application authority, the temporary setting information input before the setting application is determined, and the determined setting information after the setting application is determined, to the management device 100B.

The application unit 13 executes application addressed to the management device 100B on the basis of the information input via the application input image.

The application unit 13 includes an authority application unit 13-1 and a setting application unit 13-2.

When acquiring the authority application information for requesting the application authority via the application input image, the authority application unit 13-1 outputs the authority application information to the management device 100B.

When acquiring a determination signal indicating that the setting application is determined via the application input image, the setting application unit 13-2 outputs information (application determination notification) indicating that the application is determined to the management device 100B.

An example of processing in the first terminal 10 will be described.

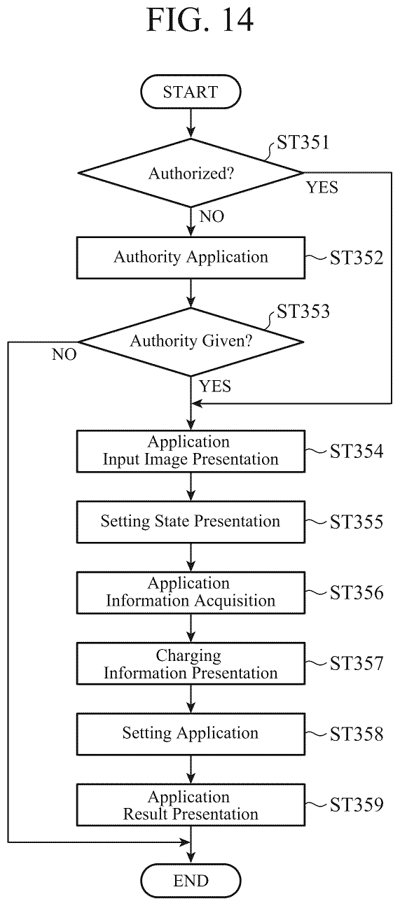

FIG. 14 is a flowchart illustrating an example of processing in the first terminal 10.

The first terminal 10 starts the processing illustrated in FIG. 14 according to the operation of the user who is the applicant.

The application unit 13 in the first terminal 10 confirms whether the applicant has authority (step ST351). The authority application unit 13-1 in the application unit 13 confirms whether a notification indicating that the authority has been given from the management device 100B has already been received.

If the application unit 13 in the first terminal 10 determines that the applicant has authority (step ST351 “YES”), the process proceeds to step ST354.

When the application unit 13 in the first terminal 10 determines that the applicant does not have authority (step ST351 “NO”), the application unit 13 in the first terminal 10 makes an authority application (step ST352). Specifically, the authority application unit 13-1 in the application unit 13 outputs the user identification information and the authority application information to the management device 100B.

The application unit 13 in the first terminal 10 determines whether authority has been given (step ST353). Specifically, the setting application unit 13-2 in the application unit 13 determines that the authority is given when acquiring the authorization notification indicating that the applicant has the application authority from the management device 100B.

In a case where the setting application unit 13-2 in the application unit 13 determines that the authority has not been given (step ST353 “NO”), the processing illustrated in FIG. 14 ends.

If the authority has been given (step ST353 “YES”), the application unit 13 in the first terminal 10 presents an application input image (step ST354).

The presentation unit 11 in the first terminal 10 presents the setting state (step ST355).

The input information output unit 12 acquires application information (step ST356). The application information includes temporary setting information. The input information output unit 12 in the first terminal 10 outputs the temporary setting information as the acquired application information to the management device 100B.

The presentation unit 11 in the first terminal 10 presents the charging information (step ST357). Specifically, the charging information presenting unit 11-4 in the presentation unit 11 acquires the predicted charge amount information from the management device 100B, and presents a charge amount image displaying the predicted charge amount using the predicted charge amount information.

The application unit 13 in the first terminal 10 makes a setting application (step ST358). Specifically, when the operation of determining the setting application is performed by the applicant in a state where the authorization notification indicating that the applicant has the application authority is received, the setting application unit 13-2 in the application unit 13 of the first terminal outputs an application determination notification indicating that the setting application of the setting information is determined to the management device 100B. At this time, the setting application unit 13-2 may output the determined setting information, which is the application information, to the management device 100B together with the application determination notification. Since the contents of the determined setting information are the same as the contents of the temporary setting information already output to the management device 100B, it is not essential for the setting application unit 13-2 to output the determined setting information together with the application determination notification.

The presentation unit 11 in the first terminal 10 presents the application result (step ST359).

After executing the processing of step ST359, the first terminal 10 ends the processing illustrated in FIG. 14.

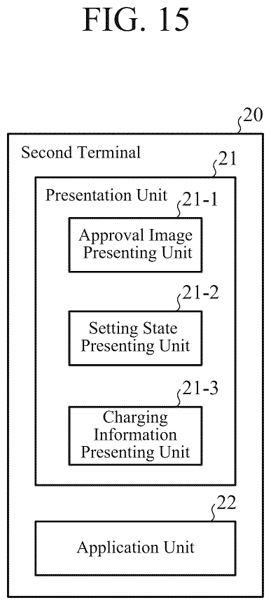

FIG. 15 is a diagram illustrating an example of a configuration of the second terminal 20.

The second terminal 20 illustrated in FIG. 15 includes a presentation unit 21 and an application unit 22.

The presentation unit 21 includes an approval image presenting unit 21-1, a setting state presenting unit 21-2, and a charging information presenting unit 21-3.

The approval image presenting unit 21-1 presents the approval image to a display unit (not illustrated) in the second terminal 20 in response to the approval confirmation request from the management device 100B.

The setting state presenting unit 21-2 acquires the setting state information from the management device 100B and presents the setting state image on the basis of the setting state information.

The charging information presenting unit 21-3 acquires the charging information from the management device 100B and presents the charging information on the basis of the charging information.

The application unit makes an application to the management device 100B on the basis of an operation of a user who possesses the second terminal 20.

The application unit 22 includes an approval application unit.

When the facility manager possessing the second terminal 20 performs an operation of approving the application authority to the applicant or the facility user via the approval image, the approval application unit outputs approval information indicating that the authorization is approved to the management device 100B.

An image of information presented by the management device 100B according to the third embodiment will be described.

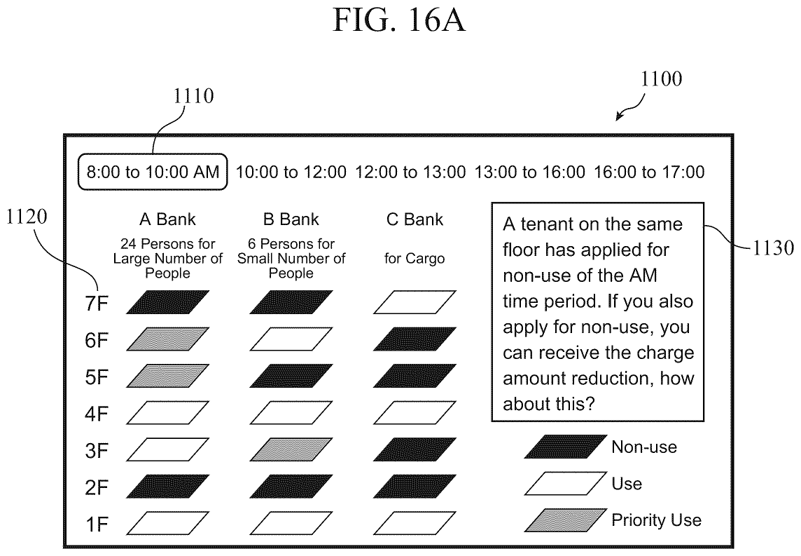

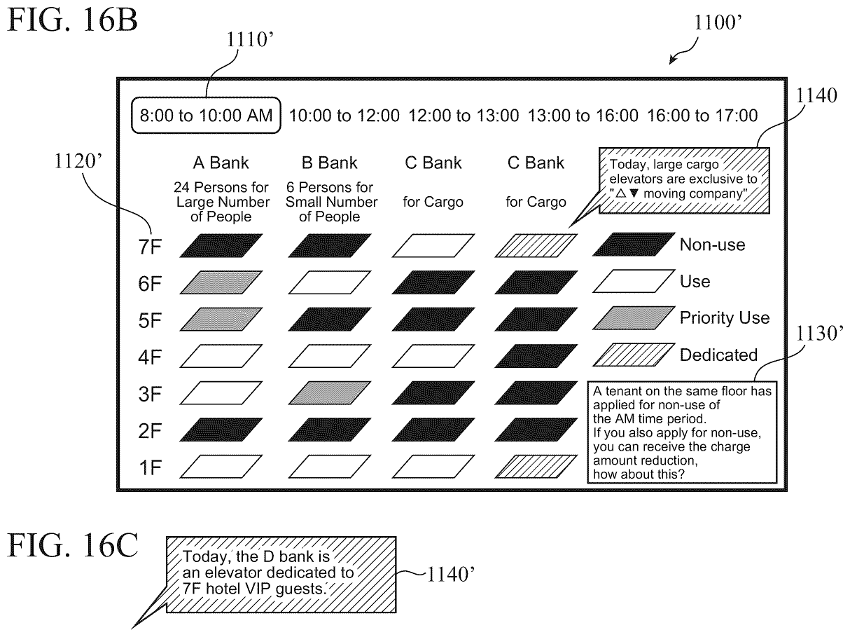

FIGS. 16A, 16B, and 16C are diagrams illustrating concepts of images presented by the management device according to the third embodiment.

A presentation image 1100 illustrated in FIG. 16A is an image constituting the operation setting application screen.

In the presentation image 1100, a time period 1110 and a level 1120 of the facility are selectably drawn. Furthermore, a comment image 1130 based on the proposal information is drawn in the presentation image 1100.

In the comment image 1130, for example, a text image such as “A tenant on the same floor has applied for non-use of the AM time period. If you also apply for non-use, you can receive the charge amount reduction, how about this?” is drawn.

This indicates that the proposal information is information including a condition for reducing the charge amount from the current charge amount with reference to the elevator operation setting database 32.

A presentation image 1100′ illustrated in FIG. 16B is an image constituting the operation setting application screen.

In the presentation image 1100′, a time period 1110 and a level 1120′ of the facility are selectably drawn. Furthermore, a comment image 1130′ based on the proposal information is drawn in the presentation image 1100′.

In the comment image 1130′, for example, a text image such as “A tenant on the same floor has applied for non-use of the AM time period. If you also apply for non-use, you can receive the charge amount reduction, how about this?” is drawn. This indicates that the proposal information is information generated with reference to the elevator operation setting database 32, and including a condition for reducing the charge amount from the current charge amount.

The presentation image 1100′ indicates that the elevator of the C bank which is an elevator for cargo is dedicated to the first floor and the seventh floor in the period of 8:00 to 10:00 AM, and a text image such as “Today, large cargo elevators are exclusive to “Δ▾ moving company”” is drawn in the comment image 1130′.

This indicates that the presentation information generated by the presentation information generating unit (111B, 121) is information presenting exclusive use of the external company.

A presentation image 1140′ illustrated in FIG. 16C is a comment image, and a text image such as “Today, the D bank is an elevator dedicated to 7F hotel VIP guests.” is drawn. This is displayed in place of, for example, the comment image 1130′ in FIG. 16B.

This indicates that the presentation information generated by the presentation information generating unit (111B, 121) is information presenting exclusive use of the tenant in the facility.

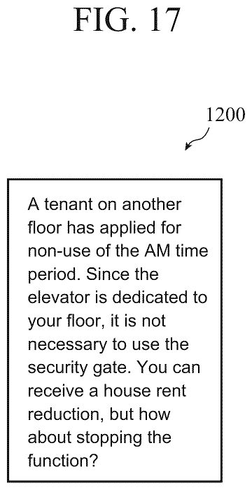

FIG. 17 is a diagram for describing a concept of information presented by the management device 100B according to the third embodiment.

A presentation image 1200 is a comment image based on the presentation information generated using the proposal information.

In the presentation image 1200, text images such as “A tenant on another floor has applied for non-use of the AM time period.”, “Since the elevator is dedicated to your floor, it is not necessary to use the security gate.”, and “You can receive a house rent reduction, but how about stopping the function?” are drawn.

This indicates that the presentation information is information including the proposal information.

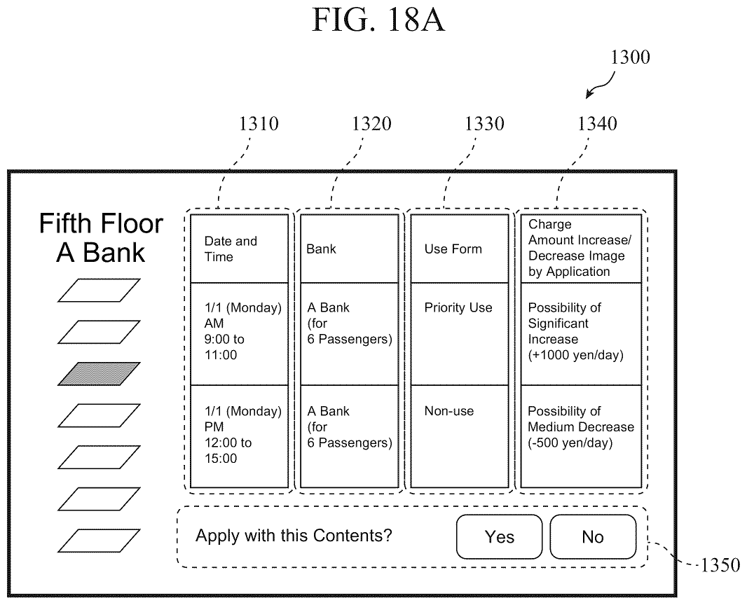

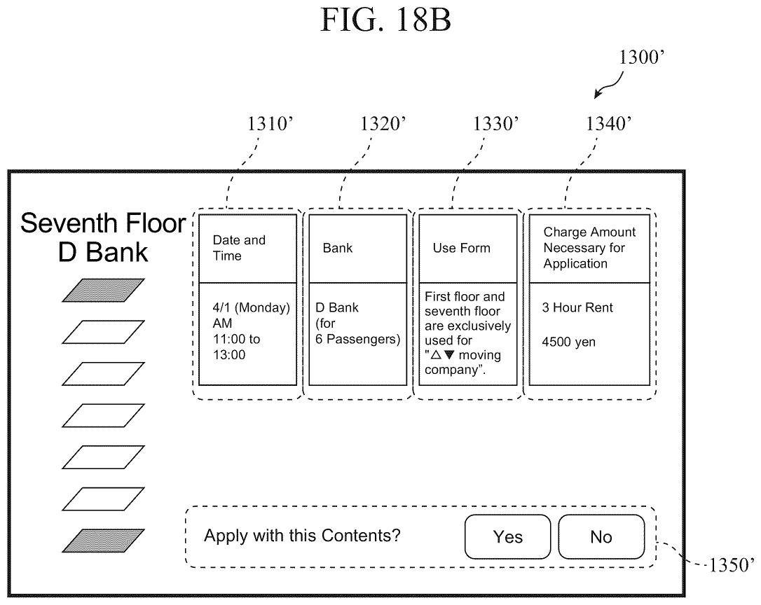

FIGS. 18A and 18B are diagrams each illustrating a concept of an image presented by the management device 100B according to the third embodiment.

A presentation image 1300 illustrated in FIG. 18A is an image constituting the operation setting application screen.

In the presentation image 1300, an operation setting that the tenant intends to apply for is drawn. Specifically, in the presentation image 1300, a date and time 1310, a bank 1320, a use form 1330, a charge amount increase/decrease image 1340 by application, and an application confirmation button 1350 are drawn. The setting application is determined by operating the application confirmation button 1350.

A presentation image 1300′ illustrated in FIG. 18B is an image constituting the operation setting application screen.

In the presentation image 1300′, an operation setting that the external company intends to apply for is drawn. Specifically, in the presentation image 1300′, a date and time 1310′, a bank 1320′, a use form 1330′, a charge amount 1340′ by application, and an application confirmation button 1350 are drawn. In the use form 1330′, “the first floor and the seventh floor are exclusively used for “Δ▾ moving company”” is described, and in the charge amount image 1340′ by application, “3 hour rent 4500 yen” is drawn. The setting application is determined by operating the application confirmation button 1350.

By using such a presentation image as an operation setting application screen and presenting the presentation image in the first terminal 10, the external company can make an application while assuming an increase or decrease in the charge amount due to the operation setting.

According to the third embodiment, a proposal suitable for a facility user (for example, a tenant) can be presented in the first terminal 10 on the basis of charging (rent) corresponding to the operation setting set using the first terminal 10 that is a terminal for the facility user (tenant).

The management device according to the present disclosure further includes a proposal generating unit to generate proposal information indicating application contents recommended for each of the applicants by using at least one of the traffic volume calculated by the traffic volume calculating unit and the charge amount calculated by the charge amount calculating unit, and the presentation information generating unit is configured to generate presentation information for the first terminal by using the proposal information generated by the proposal generating unit, and output the presentation information to the first terminal.

As a result, it is possible to provide a management device that presents a more preferable proposal to the applicant.

A setting method of the present disclosure is a setting method in which a setting application is made using a first terminal to a management device that manages setting information related to use of a facility, and the setting method is configured to include:
an authority application step of outputting, by an application unit of the first terminal, authority application information including user identification information for identifying an applicant to the management device;
an application input image presenting step of presenting, by an application input image presenting unit of the first terminal, an application input image to which an operation setting of an elevator provided in the facility can be input, by using a display unit of the first terminal;
an input information acquiring step of acquiring, by an input information output unit of the first terminal, setting information including an operation setting of the elevator provided in the facility via the application input image;
an input information output step of outputting, by an input information output unit of the first terminal, to the management device, temporary setting information before an application determination notification of the setting information is given from the first terminal to the management device;
a charging information presenting step of presenting, by a charging information presenting unit of the first terminal, a charging information image related to a charge amount corresponding to a traffic volume of an elevator when the temporary setting information is applied for setting on a basis of presentation information received by the first terminal from the management device; and
a setting application step of outputting, by the application unit of the first terminal, an application determination notification for determining a setting application of the setting information to the management device when an operation of determining a setting application is performed by the applicant in a state where an authorization notification indicating that the applicant has application authority is received.

As a result, there is an effect that it is possible to provide a management device that enables a setting change suitable for the use form using the terminal even in a situation where the use form of the facility user (the facility user including the tenant) who is the applicant is diversified.

As a result, it is possible to present the charge amount corresponding to the operation setting application to the facility user who is the setting applicant via the terminal.

### Fourth Embodiment

In the third embodiment, in the embodiment (first embodiment) of managing the authority of the facility user (tenant) who is the applicant regarding the operation setting of the equipment in the facility and the embodiment (second embodiment) of presenting the charge amount (tenant rent) to the applicant according to the operation setting of the equipment in the facility to the applicant, the embodiment of making a proposal to the applicant on the basis of the charge amount for each applicant has been described.

The fourth embodiment is an embodiment in which a charge amount change can be applied for using a first terminal that is a terminal for a facility user who is an applicant.

The fourth embodiment includes the configuration already described in the first embodiment, the configuration already described in the second embodiment, or the configuration already described in the third embodiment in order to illustrate an embodiment in which a function is added in addition to the first embodiment, the second embodiment, or the third embodiment. In the fourth embodiment, the description of the configuration already described in the first embodiment, the second embodiment, and the third embodiment will be appropriately omitted.

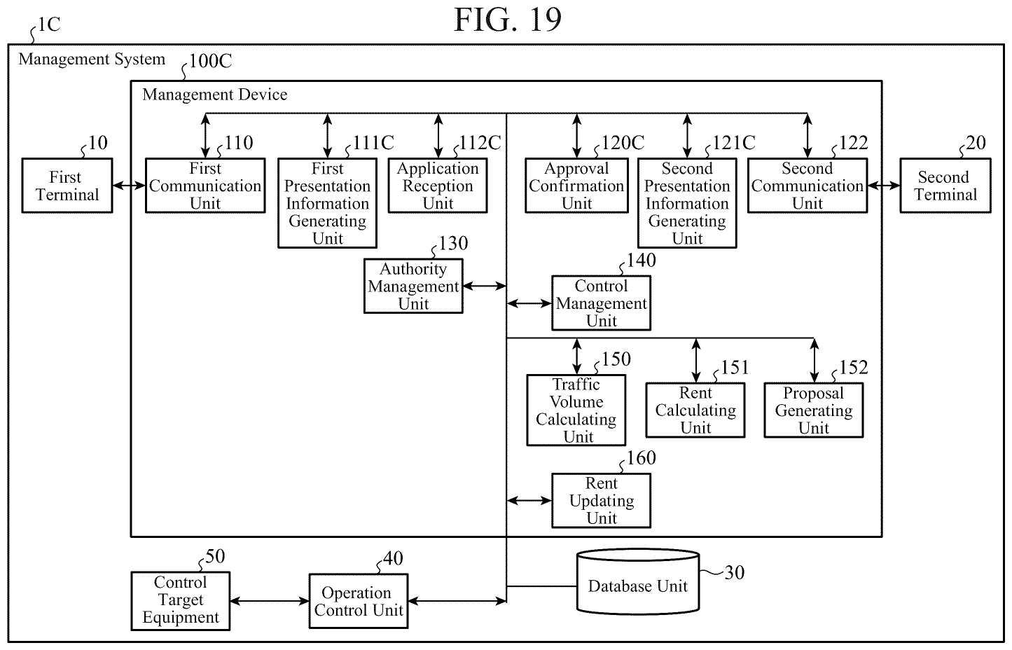

FIG. 19 is a diagram illustrating a first configuration example of a management device according to the fourth embodiment of the present disclosure and a management system including the management device.

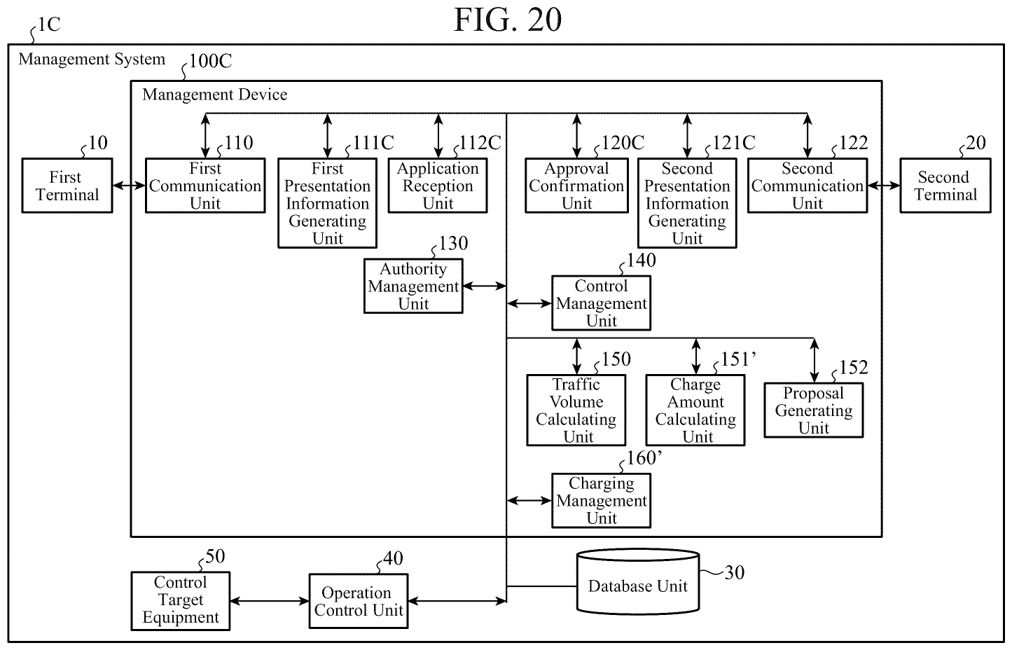

FIG. 20 is a diagram illustrating a second configuration example of the management device according to the fourth embodiment of the present disclosure and the management system including the management device.

A management system 1C includes a first terminal 10, a second terminal 20, a database unit 30, an operation control unit 40, a control target equipment 50, and a management device 100C.

Each of the first terminal 10, the second terminal 20, the operation control unit 40, and the control target equipment 50 has a configuration similar to the configuration illustrated in FIG. 1, and a detailed description thereof will be omitted here.

Since the database unit 30 is the same as the database unit 30 or the database unit 30A described above, a detailed description thereof will be omitted here.

A management device 100C illustrated in FIG. 19 includes a first communication unit 110, a first presentation information generating unit 111C, an application reception unit 112C, an approval confirmation unit 120C, a second presentation information generating unit 121C, a second communication unit 122, an authority management unit 130, a control management unit 140, a traffic volume calculating unit 150, a rent calculating unit 151, a proposal generating unit 152, a rent updating unit 160, and a control unit (not illustrated).

A management device 100C illustrated in FIG. 20 includes a first communication unit 110, a first presentation information generating unit 111C, an application reception unit 112C, an approval confirmation unit 120C, a second presentation information generating unit 121C, a second communication unit 122, an authority management unit 130, a control management unit 140, a traffic volume calculating unit 150, a charge amount calculating unit 151′, a proposal generating unit 152, a charging management unit 160′, a control unit (not illustrated), and the like.

That is, the management device 100C further includes a rent updating unit 160 or a charging management unit 160′ with respect to the management device 100, the management device 100A, or the management device 100B.

In addition, the management device 100C changes a first presentation information generating unit 111C, an application reception unit 112C, an approval confirmation unit 120C, and a second presentation information generating unit 121C with respect to the management device 100, the management device 100A, or the management device 100B.

The control unit (not illustrated) performs overall control of the management device 100C. For example, control such as activation and stop of the management device 100 is performed.

Each of the first communication unit 110, the second communication unit 122, the authority management unit 130, the control management unit 140, the traffic volume calculating unit 150, the rent calculating unit 151, the charge amount calculating unit 151′, and the proposal generating unit 152 is similar to the configuration already described, and the detailed description thereof will be omitted here.

The first presentation information generating unit 111C is obtained by adding a function to the first presentation information generating unit 111B illustrated in FIG. 10.

The first presentation information generating unit 111C refers to the elevator operation setting database 32 storing the operation setting information regarding the operation of each elevator to acquire the current operation setting information, and generates presentation information including an operation setting image that enables operation for the operation setting application and the charge amount change application by using the operation setting information.

The application reception unit 112C is obtained by adding a function to the application reception unit 112 illustrated in FIG. 10.

The application reception unit 112C receives the operation setting application on the basis of the content of the operation setting set for the operation setting image in the first terminal 10.

In addition, the application reception unit 112C receives the charge amount change application on the basis of the content of the operation setting set for the operation setting image in the first terminal 10.

The approval confirmation unit 120C is obtained by adding a function to the approval confirmation unit 120 illustrated in FIG. 10.

When the application reception unit 112 receives the operation setting application and the charge amount change application, the approval confirmation unit 120C generates charge amount inquiry information for confirming to the second terminal 20, which is a terminal for a facility manager, whether or not to approve the charge amount according to the applied operation setting content.

When receiving the approval information from the second terminal 20 after outputting the charge amount inquiry information, the approval confirmation unit 120C notifies the charging management unit 160′ (rent updating unit 160) of the approval.

The second presentation information generating unit 121C is obtained by adding a function to the second presentation information generating unit 121 illustrated in FIG. 10.

When acquiring the charge amount inquiry information from the approval confirmation unit 120C, the second presentation information generating unit 121C generates presentation information for the second terminal 20 on the basis of the charge amount inquiry information.

In the case of including the rent updating unit 160, when the approval confirmation unit 120 receives approval information indicating that the charge amount is approved from the second terminal 20, the rent updating unit 160 updates the charging database 36A storing the charge amount determined for each tenant using the approved charge amount.

In the case of including the charging management unit 160′, when the approval confirmation unit 120 receives the approval information indicating that the charge amount is approved from the second terminal 20, the charging management unit 160′ updates the charging database 36A storing the charge amount determined for each applicant using the approved charge amount.

In the management device 100C illustrated in FIGS. 19 and 20, the first communication unit and the second communication unit are separately illustrated, but the first communication unit and the second communication unit may be configured by one communication unit.

In the management device 100 in FIGS. 19 and 20, the first presentation information generating unit 111 and the second presentation information generating unit 121 are separately illustrated, but the first presentation information generating unit 111 and the second presentation information generating unit 121 may be configured by one presentation information generating unit. In this case, one presentation information generating unit generates presentation information for the first terminal 10 or presentation information for the second terminal 20. The presentation information for the first terminal 10 is output to the first terminal 10 via the first communication unit 110. The presentation information for the second terminal 20 is output to the second terminal 20 via the second communication unit 122.

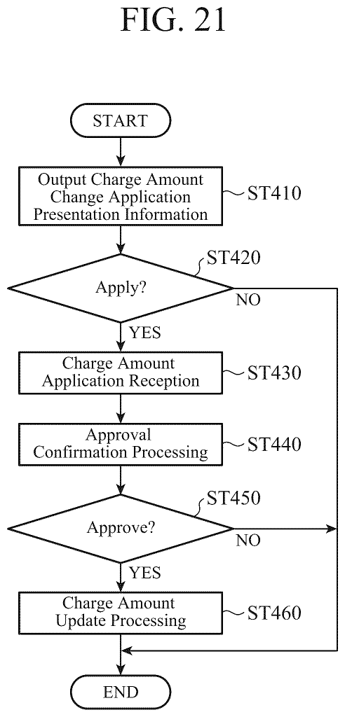

FIG. 21 is a flowchart illustrating an example of processing in the management device according to the fourth embodiment of the present disclosure.

When receiving a request for starting the operation setting application and the charge amount change application from the first terminal 10 via the first communication unit 110, the management device 100C starts the processing illustrated in FIG. 14.

When the processing illustrated in FIG. 14 is started, first, the first presentation information generating unit 111 outputs charge amount change application presentation information (step ST410).

Next, the application reception unit 112C determines whether the applicant (tenant) makes an application (step ST420).

Specifically, when receiving the operation setting application and the charge amount change application from the first terminal 10 via the first communication unit 110, the application reception unit 112C determines that the applicant (tenant) makes an application.

In a case where the application reception unit 112C determines that the applicant (tenant) does not make an application (step ST420 “NO”), the processing illustrated in FIG. 14 ends.

When the application reception unit 112C determines that the applicant (tenant) makes an application (step ST420 “YES”), the application reception unit 112C then receives the charge amount application (step ST430).

Specifically, the application reception unit 112C confirms the contents of the operation setting application and the charge amount change application from the first terminal 10, and notifies the approval confirmation unit 120C of the contents of the operation setting application and the charge amount change application.

Next, the approval confirmation unit 120C executes approval confirmation processing (step ST440).

Specifically, the approval confirmation unit 120C generates charge amount inquiry information for confirming to the second terminal 20, which is a terminal for the facility manager, whether or not to approve the charge amount according to the applied operation setting content.

Next, the approval confirmation unit 120C determines whether the facility manager approves (step ST450).

Specifically, the approval confirmation unit 120C waits for a response from the second terminal 20, and when receiving the approval information from the second terminal 20, determines that the facility manager has approved, and notifies the charging management unit 160′ (the rent updating unit 160) that the charge amount change application has been approved.

On the other hand, when having received the non-approval information indicating non-approval or, for example, when not having received the approval information within a predetermined constant time, the approval confirmation unit 120C determines that the facility manager has not approved (step ST450 “NO”), and notifies the application reception unit 112C of the non-approval. In this case, the application reception unit 112C further outputs information indicating that the charge amount change application is non-approved to the first terminal 10 via the first presentation information generating unit 111 and the first communication unit 110, and the processing illustrated in FIG. 14 ends.

If the approval confirmation unit 120C determines to approve (step ST450 “YES”), the charging management unit 160′ (rent updating unit 160) executes charge amount update processing (step ST460).

After the charging management unit 160′ (rent updating unit 160) executes the charge amount update processing, the processing illustrated in FIG. 14 ends.

According to the fourth embodiment, the applicant (tenant) can apply for house rent change by using the first terminal 10 which is a terminal for a facility user (tenant) who is an applicant. In addition, the management device 100 can change the house rent for the applicant (tenant) on the basis of the house rent change application applied using the first terminal 10 which is a terminal for a facility user (tenant) who is the applicant.

The management device according to the present disclosure further includes a presentation information generating unit that generates presentation information for the first terminal or presentation information for the second terminal, in which the presentation information generating unit acquires the current operation setting information with reference to an elevator operation setting database that stores operation setting information regarding operation for each elevator, and generates presentation information including an operation setting image that enables operation for the operation setting application using the operation setting information, and the application reception unit receives the operation setting application on the basis of content of the operation setting set for the operation setting image in the first terminal.

As a result, in the first terminal, since the current setting content is included in the image to be applied, it is possible to provide a graphic user interface in which the setting content to be changed can be easily input by the applicant (facility user including a tenant).

The management device according to the present disclosure further includes a charging management unit to update a charging database storing a charge amount determined for each tenant, in a case where the approval confirmation unit, when the application reception unit receives the operation setting application, confirms, to the second terminal that is a terminal for a facility manager, whether or not to approve a charge amount according to the applied operation setting content, and the approval confirmation unit receives approval information indicating that the charge amount is approved from the second terminal, by using the approved charge amount.

As a result, there is an effect that the first terminal can apply for a change in the charge amount.

### Fifth Embodiment

In the fourth embodiment, an embodiment has been described in which the charge amount change application from the applicant (tenant) is enabled, and the charge amount for the applicant (tenant) is changed on the basis of the charge amount change application.

The fifth embodiment is an embodiment of presenting an operation schedule or an operation status according to the content of an operation setting set using the first terminal 10 which is a terminal for a facility user (tenant) who is an applicant.

The fifth embodiment includes the configuration already described in the first embodiment, the configuration already described in the second embodiment, the configuration already described in the third embodiment, or the configuration already described in the fourth embodiment in order to illustrate an embodiment in which a function is added in addition to the first embodiment, the second embodiment, the third embodiment, or the fourth embodiment. In the fifth embodiment, the description of the configurations described in the first embodiment, the second embodiment, the third embodiment, and the fourth embodiment will be appropriately omitted.

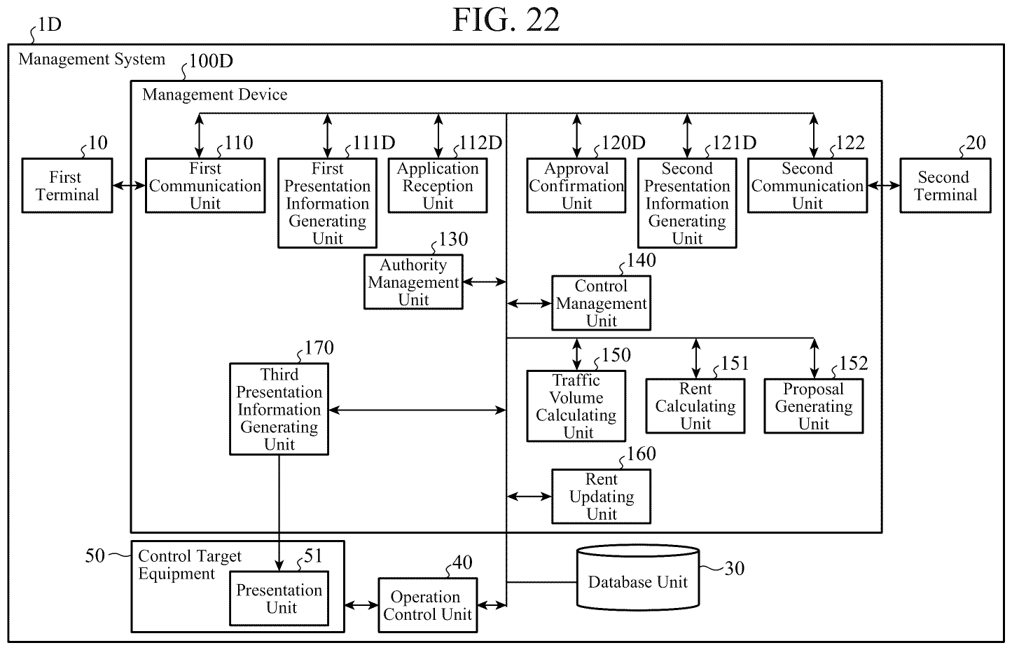

FIG. 22 is a diagram illustrating a first configuration example of a management device 100D according to the fifth embodiment of the present disclosure and a management system 1D including the management device.

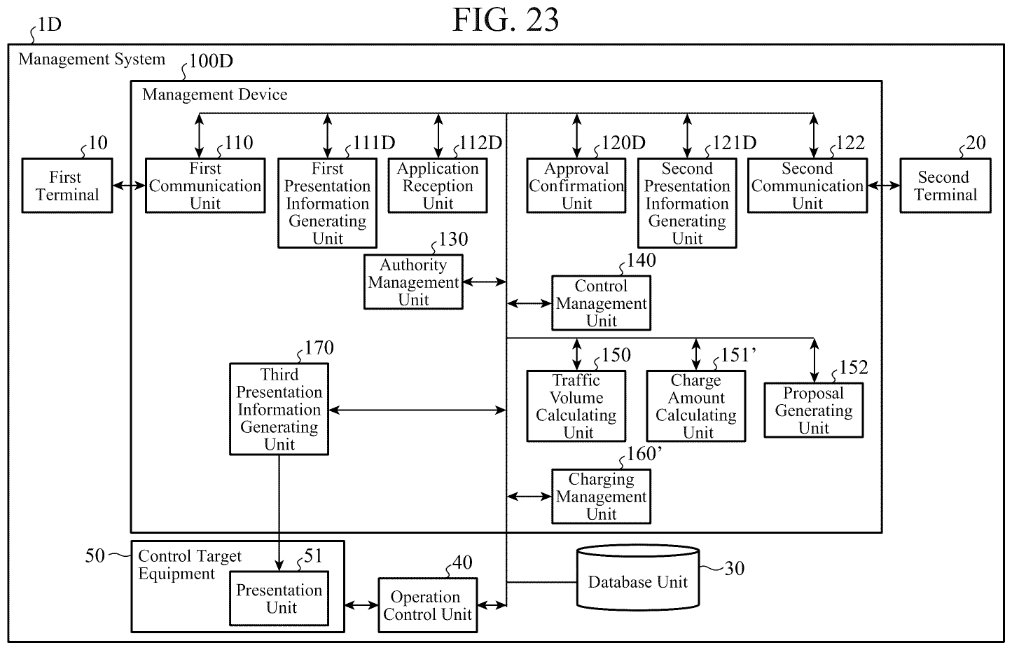

FIG. 23 is a diagram illustrating a second configuration example of the management device 100D according to the fifth embodiment of the present disclosure and the management system 1D including the management device.

The management system 1D includes a first terminal 10, a second terminal 20, a database unit 30, an operation control unit 40, a control target equipment 50, and a management device 100D.

The database unit 30 may be the database unit 30A.

Each of the first terminal 10, the second terminal 20, the database unit 30, the database unit 30A, and the operation control unit 40 has a configuration similar to the configuration already described, and the detailed description thereof will be omitted here.

The control target equipment 50 illustrated in FIG. 22 or 23 includes a presentation unit 51. The presentation unit 51 is a display.

A management device 100D illustrated in FIG. 22 includes a first communication unit 110, a first presentation information generating unit 111D, an application reception unit 112D, an approval confirmation unit 120D, a second presentation information generating unit 121D, a second communication unit 122, an authority management unit 130, a control management unit 140, a traffic volume calculating unit 150, a rent calculating unit 151, a proposal generating unit 152, a rent updating unit 160, a third presentation information generating unit 170, a control unit (not illustrated), and the like.

A management device 100D illustrated in FIG. 23 includes a first communication unit 110, a first presentation information generating unit 111D, an application reception unit 112D, an approval confirmation unit 120D, a second presentation information generating unit 121D, a second communication unit 122, an authority management unit 130, a control management unit 140, a traffic volume calculating unit 150, a charge amount calculating unit 151′, a proposal generating unit 152, a charging management unit 160′, a third presentation information generating unit 170, a control unit (not illustrated), and the like.

That is, the management device 100D further includes the third presentation information generating unit 170 with respect to the management device 100, the management device 100A, the management device 100B, or the management device 100C.

In addition, the management device 100D is different from the management device 100, the management device 100A, the management device 100B, or the management device 100C in including a first presentation information generating unit 111D, an application reception unit 112D, an approval confirmation unit 120D, and a second presentation information generating unit 121D.

Each of the first communication unit 110, the second communication unit 122, the authority management unit 130, the control management unit 140, the traffic volume calculating unit 150, the rent calculating unit 151, the charge amount calculating unit 151′, the proposal generating unit 152, the rent updating unit 160, and the charging management unit 160′ has a configuration similar to the configuration described above, and detailed description thereof will be omitted here.

The control unit (not illustrated) performs overall control of the management device 100D. For example, control such as activation and stop of the management device 100 is performed.

The first presentation information generating unit 111D is obtained by adding a function to the first presentation information generating unit 111C illustrated in FIG. 19.

When receiving the request from the first terminal 10 via the first communication unit 110, the first presentation information generating unit 111D outputs the presentation information according to the content of the request.

The first presentation information generating unit 111D further outputs at least one of the operation schedule image and the operation status image in addition to the functions of the first to fourth embodiments.

Specifically, the first presentation information generating unit 111D refers to the elevator operation setting database 32 that stores operation setting information regarding operation of each elevator to acquire current operation setting information, generates presentation information including an operation schedule image indicating an operation schedule of the elevator or an operation status image indicating an operation status of the elevator, and outputs the presentation information to the first terminal 10.

Further, the first presentation information generating unit 111D further acquires the operation status information indicating the current operation status of the elevator from the operation control unit 40 that controls the operation of the elevator, generates the presentation information including the operation schedule image indicating the operation schedule of the elevator or the operation status image indicating the operation status of the elevator by using the operation status information and the operation setting information, and outputs the presentation information to the first terminal 10.

The application reception unit 112D is similar to the application reception unit 112C illustrated in FIG. 19, and a detailed description thereof will be omitted here.

The approval confirmation unit 120D is similar to the approval confirmation unit 120C illustrated in FIG. 19, and a detailed description thereof will be omitted here.

When receiving the request from the second terminal 20 via the second communication unit 122, the second presentation information generating unit 121D outputs the presentation information according to the content of the request.

The second presentation information generating unit 121D further outputs at least one of the operation schedule image and the operation status image in addition to the functions of the first to fourth embodiments.

Specifically, the second presentation information generating unit 121D refers to the elevator operation setting database 32 that stores operation setting information regarding operation of each elevator to acquire current operation setting information, generates presentation information including an operation schedule image indicating an operation schedule of the elevator or an operation status image indicating an operation status of the elevator, and outputs the presentation information to the second terminal 20.

Further, the second presentation information generating unit 121D further acquires the operation status information indicating the current operation status of the elevator from the operation control unit 40 that controls the operation of the elevator, generates the presentation information including the operation schedule image indicating the operation schedule of the elevator or the operation status image indicating the operation status of the elevator by using the operation status information and the operation setting information, and outputs the presentation information to the second terminal 20.

The third presentation information generating unit 170 outputs at least one of the operation schedule image and the operation status image to the presentation unit of the elevator.

Specifically, when the operation of the elevator is started, the third presentation information generating unit 170 refers to the elevator operation setting database 32 storing operation setting information regarding the operation of each elevator to acquire current operation setting information, further generates presentation information including an operation schedule image indicating an operation schedule of the elevator or an operation status image indicating an operation status of the elevator, and outputs the presentation information to the presentation unit provided in the elevator.

In addition, the third presentation information generating unit 170 further acquires operation status information indicating the current operation status of the elevator from the operation control unit 40 that controls the operation of the elevator, further generates presentation information including an operation schedule image indicating the operation schedule of the elevator or an operation status image indicating the operation status of the elevator by using the operation status information and the operation setting information, and outputs the presentation information to the presentation unit provided in the elevator.

In the management device 100 illustrated in FIGS. 22 and 23, the first communication unit and the second communication unit are separately illustrated, but the first communication unit and the second communication unit may be configured by one communication unit.

In the management device 100 illustrated in FIGS. 22 and 23, the first presentation information generating unit 111, the second presentation information generating unit 121, and the third presentation information generating unit 170 are separately illustrated. However, the first presentation information generating unit 111, the second presentation information generating unit 121, and the third presentation information generating unit 170 may be configured by one presentation information generating unit. In this case, one presentation information generating unit generates presentation information for the first terminal 10, presentation information for the second terminal 20, or presentation information for a presentation unit in the elevator. The presentation information for the first terminal 10 is output to the first terminal 10 via the first communication unit 110. The presentation information for the second terminal 20 is output to the second terminal 20 via the second communication unit 122. The presentation information for the presentation unit in the elevator is output to the presentation unit in the elevator.

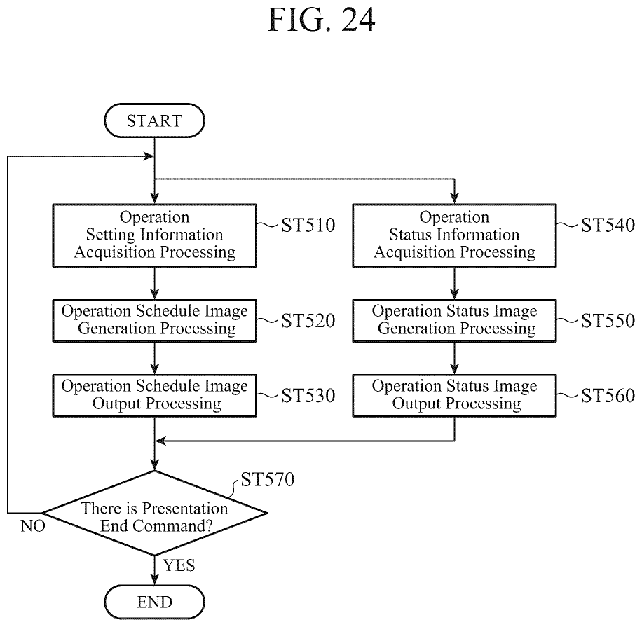

FIG. 24 is a flowchart illustrating an example of processing in the management device according to the fifth embodiment of the present disclosure.

When the processing illustrated in FIG. 16 is started, the management device 100D executes processing from step ST510 and processing from step ST540.

The third presentation information generating unit 170 executes operation setting information acquisition processing (step ST510).

Specifically, the third presentation information generating unit 170 refers to the elevator operation setting database 32 storing the operation setting information regarding the operation of each elevator to acquire the current operation setting information.

Next, the third presentation information generating unit 170 executes operation schedule image generation processing (step ST520).

Specifically, the third presentation information generating unit 170 generates presentation information including an operation schedule image indicating an operation schedule of the elevator or an operation status image indicating an operation status of the elevator.

Next, the third presentation information generating unit 170 executes operation schedule image output processing (step ST530).

Specifically, the third presentation information generating unit 170 outputs the presentation information generated in step ST530 to a presentation unit provided in the elevator.

In addition, the third presentation information generating unit 170 executes operation status information acquisition processing in parallel with the processing from step ST510 to step ST530 (step ST540).

Specifically, the third presentation information generating unit 170 further acquires the operation status information indicating the current operation status of the elevator from the operation control unit 40 that controls the operation of the elevator.

Next, the third presentation information generating unit 170 executes operation status image generation processing (step ST550).

Specifically, the third presentation information generating unit 170 generates presentation information including an operation schedule image indicating the operation schedule of the elevator or an operation status image indicating the operation status of the elevator by using the operation status information and the operation setting information.

Next, the third presentation information generating unit 170 executes operation status image output processing (step ST560).

Specifically, the third presentation information generating unit 170 outputs the presentation information generated in step ST550 to a presentation unit provided in the elevator.

Next, the third presentation information generating unit 170 determines whether there is a presentation end command (step ST570).

If it is determined in the processing of step ST570 that there is no presentation end command (step ST570 “NO”), the processing from step ST510 to step ST530 and the processing from step ST540 to step ST570 are repeated.

If it is determined in the processing of step ST570 that there is a presentation end command (step ST570 “YES”), the processing illustrated in FIG. 24 ends.

Note that, in the fifth embodiment, after the rent updating unit 160 updates the rent or after the charging management unit 160′ updates the charge amount, the proposal generating unit 152 may propose the rent change application or the charge amount change application again in consideration of the actual use efficiency while operating.

Here, a concept of information presented by the management device 100D according to the fifth embodiment will be described.

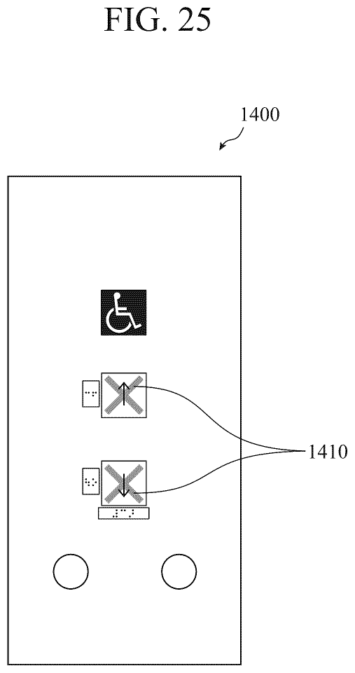

FIG. 25 is a diagram illustrating a concept of an image presented by the management device 100D according to the fifth embodiment.

Presentation information 1400 indicates that a mark 1410 indicating that the call button cannot be used is superimposed on the call button provided in the waiting place of the elevator. This is a case where the operation setting information used for generating the presentation information indicates that the entire building is unused.

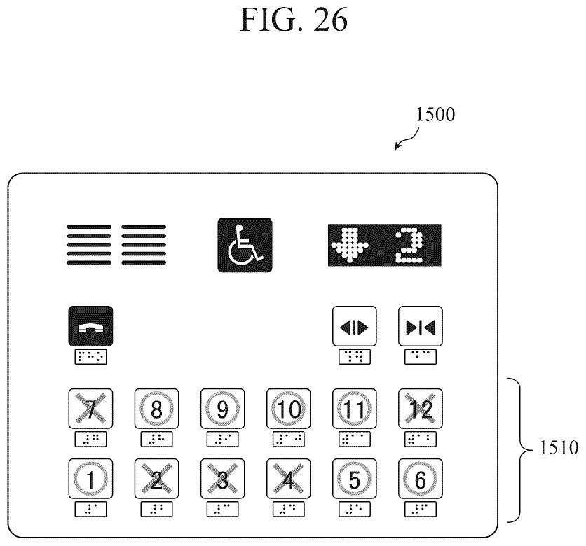

FIG. 26 is a diagram illustrating a concept of an image presented by the management device 100D according to the fifth embodiment.

Presentation information 1500 indicates a panel that designates a destination floor provided in the cage of the elevator car.

In the presentation information 1500, a mark indicating whether designation is possible or not is superimposed on a button 1510 indicating each floor.

This indicates a case where use or non-use is set for each floor in the operation setting information used for creating the presentation information.

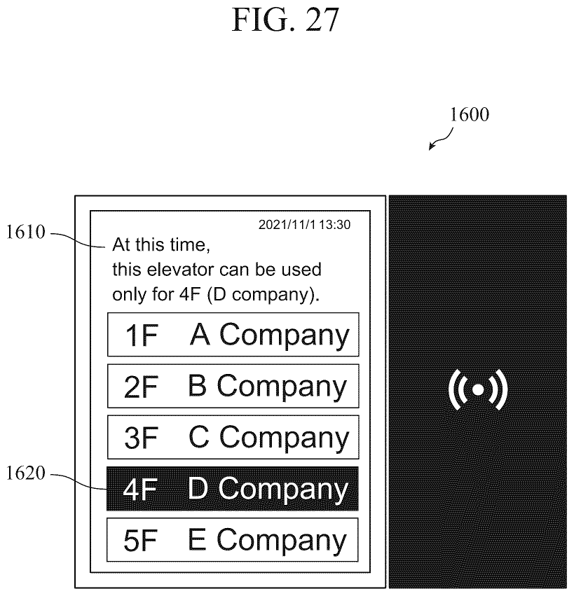

FIG. 27 is a diagram illustrating a concept of an image presented by the management device 100D according to the fifth embodiment.

Presentation information 1600 indicates a case of being presented on a display device in a form of touching an ID card.

In the presentation information 1600, a message image 1610 “At this time, this elevator can be used only for 4F (D company).” is displayed, and it is indicated that only a button 1620 of “4F D company” is selectable.

According to the fifth embodiment, the management device 100 can present the operation schedule or the operation status to the first terminal 10 or the facility user according to the content of the operation setting set using the first terminal 10 which is a terminal for a tenant.

In the management device according to the present disclosure, the presentation information generating unit is a unit that further generates presentation information for a presentation unit provided in the elevator, refers to an elevator operation setting database storing operation setting information regarding operation of each elevator to acquire the current operation setting information, further generates presentation information including an operation schedule image indicating an operation schedule of the elevator or an operation status image indicating an operation status of the elevator, and outputs the presentation information to the first terminal, the second terminal, or the presentation unit provided in the elevator.

As a result, it is possible to provide useful information to the applicant (facility user including a tenant) or the user of the elevator.

In the management device according to the present disclosure, the presentation information generating unit further acquires operation status information indicating a current operation status of the elevator from an operation control unit that controls operation of the elevator, further generates presentation information including an operation schedule image indicating an operation schedule of the elevator or an operation status image indicating an operation status of the elevator by using the operation status information and the operation setting information, and outputs the presentation information to the first terminal, the second terminal, or the presentation unit provided in the elevator.

As a result, it is possible to provide more useful information to the applicant (facility user including a tenant) or the user of the elevator.

Here, a hardware configuration that implements the functions of the management device 100 (100A, 100B, 100C, 100D) according to the present disclosure will be described.

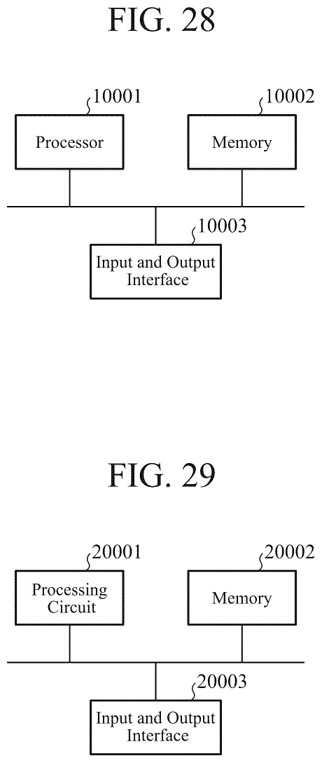

FIG. 28 is a diagram illustrating a first example of a hardware configuration for implementing the functions according to the present disclosure.

FIG. 29 is a diagram illustrating a second example of a hardware configuration for implementing the functions according to the present disclosure.

The management device 100 (100A, 100B, 100C, 100D) of the present disclosure is implemented by hardware as illustrated in FIG. 28 or 29.

As illustrated in FIG. 28, the management device 100 (100A, 100B, 100C, 100D) includes a processor 10001 and a memory 10002.

The processor 10001 and the memory 10002 are mounted on a computer, for example.

The memory 10002 stores a program for causing the computer to function as a first presentation information generating unit 111 (111, 111A, 111B, 111C, 111D), an application reception unit 112 (112, 112C, 112D), an approval confirmation unit (120, 120C, 120D), a second presentation information generating unit 121 (121, 121C, 121D), an authority management unit 130, a control management unit 140, a traffic volume calculating unit 150, a rent calculating unit 151, a charge amount calculating unit 151′, a proposal generating unit 152, a rent updating unit 160, a charging management unit 160′, a third presentation information generating unit 170, and a control unit not illustrated. The processor 10001 reads and executes the program stored in the memory 10002, thereby implementing the functions of the first presentation information generating unit 111 (111, 111A, 111B, 111C, 111D), the application reception unit 112 (112, 112C, 112D), the approval confirmation unit (120, 120C, 120D), the second presentation information generating unit 121 (121, 121C, 121D), the authority management unit 130, the control management unit 140, the traffic volume calculating unit 150, the rent calculating unit 151, the charge amount calculating unit 151′, the proposal generating unit 152, the rent updating unit 160, the charging management unit 160′, the third presentation information generating unit 170, and a control unit not illustrated.

In addition, a storage unit (not illustrated), a database unit 30, an authority management database 31, an elevator operation setting database 32, a security equipment operation management database 33, a rent database for calculation 34, a charge amount database for calculation 34A, an application history database 35, a rent database 36, a charging database 36A, an operation status database 37, and the like are implemented by the memory 10002 or another memory (not illustrated).

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magneto-optical disk.

The processor 10001 and the memory 10002 are connected in a state in which data can be transmitted to each other. In addition, the processor 10001 and the memory 10002 are connected in a state in which data can be mutually transmitted with other hardware via an input and output interface 10003.

Alternatively, the functions of the first presentation information generating unit 111 (111, 111A, 111B, 111C, 111D), the application reception unit 112 (112, 112C, 112D), the approval confirmation unit (120, 120C, 120D), the second presentation information generating unit 121 (121, 121C, 121D), the authority management unit 130, the control management unit 140, the traffic volume calculating unit 150, the rent calculating unit 151, the charge amount calculating unit 151′, the proposal generating unit 152, the rent updating unit 160, the charging management unit 160′, the third presentation information generating unit 170, and the control unit (not illustrated) may be implemented by a dedicated processing circuit 20001 as illustrated in FIG. 29.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

In addition, a storage unit (not illustrated) or a database unit 30, 30A is implemented by the memory 20002 or another memory (not illustrated).

The memory 20002 may be a nonvolatile or volatile semiconductor memory such as a random access memory (RAM), a read only memory (ROM), an erasable programmable ROM (EPROM), an electrically erasable programmable Read Only Memory (EEPROM), or a flash memory, may be a magnetic disk such as a hard disk or a flexible disk, may be an optical disk such as a compact disc (CD) or a digital versatile disc (DVD), or may be a magneto-optical disk.

The processing circuit 20001 and the memory 20002 are connected in a state in which data can be transmitted to each other. In addition, the processing circuit 20001 and the memory 20002 are connected in a state in which data can be mutually transmitted with other hardware via the input and output interface 20003.

Note that the functions of the first presentation information generating unit 111 (111, 111A, 111B, 111C, 111D), the application reception unit 112 (112, 112C, 112D), the approval confirmation unit (120, 120C, 120D), the second presentation information generating unit 121 (121, 121C, 121D), the authority management unit 130, the control management unit 140, the traffic volume calculating unit 150, the rent calculating unit 151, the charge amount calculating unit 151′, the proposal generating unit 152, the rent updating unit 160, the charging management unit 160′, the third presentation information generating unit 170, and the control unit (not illustrated) may be implemented by different processing circuits, or may be collectively implemented by a processing circuit.

Alternatively, a part of the functions of the first presentation information generating unit 111 (111, 111A, 111B, 111C, 111D), the application reception unit 112 (112, 112C, 112D), the approval confirmation unit (120, 120C, 120D), the second presentation information generating unit 121 (121, 121C, 121D), the authority management unit 130, the control management unit 140, the traffic volume calculating unit 150, the rent calculating unit 151, the charge amount calculating unit 151′, the proposal generating unit 152, the rent updating unit 160, the charging management unit 160′, the third presentation information generating unit 170, and the control unit (not illustrated) may be implemented by a processor 10001 and a memory 10002, and the remaining functions may be implemented by a processing circuit 10004.

Note that, within the scope of the present invention, free combinations of the individual embodiments, deformation of any component of the individual embodiments, or omission of any component of the individual embodiments are possible.

### INDUSTRIAL APPLICABILITY

The management device according to the present disclosure is suitable for use in, for example, a management device that manages application contents from a tenant for operation settings of an elevator provided in a building.

### REFERENCE SIGNS LIST

1, 1A, 1B, 1C, 1D: management system, 10: first terminal, 20: second terminal, 30, 30A: database unit, 31: authority management database, 32: elevator operation setting database, 33: security equipment operation management database, 34: calculation rent database, 34A: charge amount database for calculation, 35: application history database, 36: rent database, 36A: charging database, 37: operation status database, 40: operation control unit, 50: control target equipment, 51: presentation unit, 100, 100A, 100B, 100C, 100D: management device, 110: first communication unit, 111, 111A, 111B, 111C, 111D: first presentation information generating unit, 112, 112C, 112D: application reception unit, 120, 120C, 120D: approval confirmation unit, 121, 121C, 121D: second presentation information generating unit, 122: second communication unit, 130: authority management unit, 140: control management unit, 150: traffic volume calculating unit, 151: rent calculating unit, 151′: charge amount calculating unit, 152: proposal generating unit, 160: rent updating unit, 160′: charging management unit, 170: third presentation information generating unit, 1000: management information, 1100: presentation image, 1110: time period, 1120: facility layer, 1130: comment image, 1200: presentation image, 1300: presentation image, 1310: date and time, 1320: bank, 1330: usage form, 1340: image of house rent increase/decrease due to application, 1350: application confirmation button, 1400: presentation information, 1410: mark, 1500: presentation information, 1510: button indicating each floor, 1600: presentation information, 1610: message image, 1620: button, 10001: processor, 10002: memory, 10003: input and output interface, 20001: processing circuit, 20002: memory, 20003: input and output interface

1. A management device that manages a setting related to use of a facility, the management device comprising:
processing circuitry to perform:
to receive, via a first terminal, an authority application indicating that an authority to make an operation setting related to an elevator provided in the facility has been requested from a facility user who is an applicant, or an operation setting application including a content of the operation setting of the elevator provided in the facility;
to confirm to a second terminal whether or not to approve the authority application received;
to manage an authority of the operation setting application to the first terminal, the processing circuitry being configured to, when receiving approval information indicating approval of the authority application from the second terminal, give an authority to the first terminal that has requested the authority;
to, when an authority to apply for the operation setting to the first terminal is given, change a setting related to the operation of the elevator on a basis of the operation setting application received from the first terminal;
to refer to an elevator operation setting database storing operation setting information indicating a setting related to operation for each elevator and calculate a traffic volume for each elevator;
to calculate a charge amount for each of the applicants using the traffic volume calculated; and
to generate presentation information by using the charge amount for each of the applicants calculated and output the presentation information to the first terminal or the second terminal.

2. The management device according to claim 1, the processing circuitry further performing:
to generate proposal information indicating application contents recommended for each of the applicants by using at least one of the traffic volume calculated and the charge amount calculated, wherein
the processing circuitry generates presentation information for the first terminal by using the proposal information generated, and outputs the presentation information to the first terminal.

3. The management device according to claim 1, wherein
the processing circuitry acquires current operation setting information by referring to an elevator operation setting database storing the operation setting information regarding operation of each elevator, and generates presentation information including an operation setting image that enables operation for the operation setting application by using the operation setting information, and
the processing circuitry receives the operation setting application on a basis of the content of the operation setting set in the operation setting image in the first terminal.

4. The management device according to claim 3, the processing circuitry further performing
to update a charging database storing a charge amount determined for each of the applicants, in a case where the processing circuitry, when receiving the operation setting application, confirms to the second terminal whether or not to approve a charge amount according to the applied operation setting content, and the processing circuitry receives approval information indicating that the charge amount is approved from the second terminal, by using the approved charge amount.

5. The management device according to claim 1, wherein
the processing circuitry is to
further generate presentation information for a presenter provided in the elevator,
refer to an elevator operation setting database storing operation setting information regarding operation of each elevator to acquire the current operation setting information, further generate presentation information including an operation schedule image indicating an operation schedule of the elevator or an operation status image indicating an operation status of the elevator, and output the presentation information to the first terminal, the second terminal, or the presenter provided in the elevator.

6. The management device according to claim 5, wherein
the processing circuitry further acquires operation status information indicating a current operation status of the elevator from an operation controller that controls operation of the elevator, further generates presentation information including an operation schedule image indicating an operation schedule of the elevator or an operation status image indicating an operation status of the elevator by using the operation status information and the operation setting information, and outputs the presentation information to the first terminal, the second terminal, or the presenter provided in the elevator.

7. A management system comprising: a first terminal that is a terminal for a facility user, a second terminal that is a terminal for a facility manager, and a management device capable of communicating with the first terminal and the second terminal, and managing a setting related to use of a facility, wherein
the management device includes:
processing circuitry to perform:
to receive, via the first terminal, an authority application indicating that an authority to make an operation setting related to an elevator provided in the facility has been requested from the facility user who is an applicant, or an operation setting application including a content of the operation setting of the elevator provided in the facility;
to confirm to the second terminal whether or not to approve the authority application received;
to manage an authority of the operation setting application to the first terminal, processing circuitry being configured to, when receiving approval information indicating approval of the authority application from the second terminal, give an authority to the first terminal that has requested the authority;
to, when an authority to apply for the operation setting to the first terminal is given, change a setting related to the operation of the elevator on a basis of the operation setting application received from the first terminal;
to refer to an elevator operation setting database storing operation setting information indicating a setting related to operation for each elevator and calculate a traffic volume for each elevator;
to calculate a charge amount for each of the applicants using the traffic volume calculated; and
to generate presentation information by using the charge amount for each of the applicants calculated and output the presentation information to the first terminal or the second terminal.

8. A management method for managing a setting related to use of a facility, the management method comprising:
receiving via a first terminal, an authority application indicating that an authority to make an operation setting related to an elevator provided in the facility has been requested from an applicant, or an operation setting application including a content of the operation setting of the elevator provided in the facility;
confirming to a second terminal whether or not to approve the authority application received;
managing an authority of the operation setting application to the first terminal, being configured to, when receiving approval information indicating approval of the authority application from the second terminal, give an authority to the first terminal that has requested the authority;
changing when an authority to apply for the operation setting to the first terminal is given, a setting related to the operation of the elevator on a basis of the operation setting application received from the first terminal;
referring to an elevator operation setting database storing operation setting information indicating a setting related to operation for each elevator and calculating a traffic volume for each elevator;
calculating a charge amount for each of the applicants using the traffic volume calculated; and
generating presentation information by using the charge amount for each of the applicants calculated and outputting the presentation information to the first terminal or the second terminal.

9. A setting method in which a setting application is made using a first terminal to a management device that manages setting information related to use of a facility, the setting method comprising:
outputting authority application information including user identification information for identifying an applicant to the management device;
presenting, by the first terminal, an application input image to which an operation setting of an elevator provided in the facility can be input, by using a display of the first terminal;
acquiring, by the first terminal, setting information including an operation setting of the elevator provided in the facility via the application input image;
outputting, by the first terminal, to the management device, temporary setting information before an application determination notification of the setting information is given from the first terminal to the management device;
presenting, by the first terminal, a charging information image related to a charge amount corresponding to a traffic volume of an elevator when the temporary setting information is applied for setting on a basis of presentation information received by the first terminal from the management device; and
outputting, by the first terminal, an application determination notification for determining a setting application of the setting information to the management device when an operation of determining a setting application is performed by the applicant in a state where an authorization notification indicating that the applicant has application authority is received.
